(19) United States
(12) Patent Application Publication
(10) Pub. No.: US 2008/0034309 A1
(43) Pub. Date: Feb. 7, 2008

(54) Multimedia center including widgets

(76) Inventors: John O. Louch, San Luis Obispo, CA (US); Imran A. Chaudhri, San Francisco, CA (US); Thomas Madden, Redwood City, CA (US); Scott Forstall, Mountain View, CA (US)

Correspondence Address: FISH & RICHARDSON P.C., PO BOX 1022, MINNEAPOLIS, MN, 55440-1022, US

(21) Appl. No.: 11/497,801

(22) Filed: Aug. 1, 2006

(51) Int. Cl. G06F 3/048

(52) U.S. Cl. 715/766

(57) ABSTRACT

Systems, methods, computer-readable mediums, user interfaces and other implementations are disclosed for organizing, managing and presenting widgets and dashboards in a multimedia center application.

### RELATED APPLICATIONS

This application is related to the following jointly owned and co-pending patent applications, each incorporated herein by reference in its entirety:
U.S. patent application Ser. No. 10/877,968, for “Unified Interest Layer For User Interface,” filed Jun. 25, 2004;
U.S. patent application Ser. No. 11/145,561, for “Presenting Clips of Content,” filed Jun. 3, 2005;
U.S. patent application Ser. No. 11/148,010, for “Preview and Installation of User Interface Elements in a Display Environment,” filed Jun. 7, 2005;
U.S. patent application Ser. No. 11/249,139, for “Multimedia Control Center,” filed Oct. 11, 2005;
U.S. patent application Ser. No. 11/247,975, for “Multi-Media Center For Computing Systems,” filed Oct. 10, 2005; and
U.S. patent application Ser. No. 11/249,032, for “Intelligent Media Navigation,” filed Oct. 11, 2005;
U.S. patent application Ser. No. 11/282,110, for “Preview Including Theme Based Installation of User Interface Elements In A Display Environment,” filed Nov. 16, 2005;
U.S. patent application Ser. No. 11/328,493, for “Sports-Related Widgets,” filed Jan. 6, 2006; and
U.S. patent application Ser. No. 11/346,603, for “Multiple Dashboards,” filed Feb. 1, 2006;
U.S. patent application Ser. No. 11/357,730, for “Selection of User Interface Elements for Unified Display In A Display Environment,” filed Feb. 16, 2006;
U.S. patent application Ser. No. 11/403,644, for “Linked Widgets,” filed Apr. 12, 2006;
U.S. patent application Ser. No. 11/429,492, for “Management of User Interface Elements In A Display Environment,” filed May 5, 2006; and
U.S. patent application Ser. No. 11/432,295, for “Widget Security,” filed May 10, 2006.

### TECHNICAL FIELD

The subject matter of this application is generally related to graphical user interfaces.

### BACKGROUND

A hallmark of modern graphical user interfaces is that they allow a large number of graphical objects or items to be displayed on a display screen at the same time. Leading personal computer operating systems, such as Apple Mac OS®, provide user interfaces in which a number of windows can be displayed, overlapped, resized, moved, configured, and reformatted according to the needs of the user or application. Taskbars, menus, virtual buttons and other user interface elements provide mechanisms for accessing and activating windows even when they are hidden behind other windows.

Although users appreciate interfaces that can present information on a screen via multiple windows, the result can be overwhelming. For example, users may find it difficult to navigate to a particular user interface element or to locate a desired element among a large number of onscreen elements. The problem is further compounded when user interfaces allow users to position elements in a desired arrangement, including overlapping, minimizing, maximizing, and the like. Although such flexibility may be useful to the user, it can result in a cluttered display screen. Having too many elements displayed on the screen can lead to “information overload,” thus inhibiting the user to efficiently use the computer equipment.

Many of the deficiencies of conventional user interfaces can be reduced using “widgets.” Generally, widgets are user interface elements that can include information and one or more tools (e.g., applications) that let the user perform common or fixed tasks and provide fast access to information. Widgets can perform a variety of tasks, including without limitation, communicating with a remote server to provide information to the user (e.g., weather report), providing commonly needed functionality (e.g., a calculator), or acting as an information repository (e.g., a notebook). Widgets can be displayed and accessed through a user interface, such as a “dashboard layer,” which is also referred to as a “dashboard.” Widgets and dashboards are described in co-pending U.S. patent application Ser. No. 10/877,968, for “Unified Interest Layer For User Interface.”

Current trends in software development include the integration of several popular applications into a centralized application or “multimedia center” application that provides users with centralized access to content and applications, such as videos, television, music, editing tools (e.g., DVD authoring), etc. Although a multimedia center application can simplify a user's interaction with multimedia applications, if the user wants to access information not associated with the multimedia center application (e.g., weather information, news, stock quotes, etc.), then the user may have to exit the multimedia center application and invoke another application to access the desired information.

### SUMMARY

Systems, methods, computer-readable mediums, user interfaces and other implementations are disclosed for organizing, managing and presenting widgets and dashboards in a multimedia center application.

In some implementations, a method of displaying widgets includes: providing a user interface for a multimedia center application; and displaying a widget in the user interface.

In some implementations, a method of displaying widgets includes: providing a user interface for presentation on a display device; receiving a request from a remote control device to display a widget in the user interface; and displaying the widget in the user interface in response to the request.

In some implementations, a method includes: providing a user interface for presentation on a display device; and responsive to input from a remote control device, providing a set of user interface elements for presentation in the user interface, where at least some of the user interface elements are configured for providing access to multimedia applications, and at least one user interface element is configured for providing access to an application that performs a fixed task.

In some implementations, a method includes: providing a user interface for presentation on a display device; receiving a request from a remote control device to display a fixed application in the user interface, where the user interface includes user interface elements for accessing multimedia applications; and displaying output from the fixed application in the user interface in response to the request.

Other implementations are disclosed which are directed to systems, methods, apparatuses, computer-readable mediums and user interfaces.

### BRIEF DESCRIPTION OF THE DRAWINGS

FIG. 1 is a block diagram of an exemplary hardware architecture for implementing a multimedia center application including widgets.

FIG. 2 is a flow diagram of an exemplary process for activating and using a dashboard.

FIG. 3 is a block diagram of an exemplary software architecture for implementing a multimedia center application including widgets.

FIG. 4a is a screen shot depicting an exemplary desktop user interface prior to activation of a dashboard.

FIG. 4b is a screen shot depicting an exemplary initial state for a dashboard.

FIG. 4c is a screen shot depicting an exemplary configuration bar for a dashboard.

FIG. 4d is a screen shot depicting user selection of a widget from the configuration bar shown in FIG. 4c.

FIG. 4e is an exemplary screen shot depicting an installation confirmation.

FIG. 4f is an exemplary screen shot depicting a preview of a user interface element that has been selected to be installed.

FIGS. 4g-4i illustrate deletion of widgets from a configuration bar.

FIG. 5 is a block diagram of an exemplary installer process.

FIG. 6 is a flow diagram of an exemplary process for installing a user interface element in a display environment.

FIG. 7a illustrates an exemplary user interface for a widget manager.

FIG. 7b illustrates an exemplary widget manager overlay for requesting a user to confirm the deletion of a widget.

FIG. 8a illustrates an exemplary user interface for a multimedia center application including widgets.

FIG. 8b illustrates an exemplary process for displaying widgets in a multimedia center application.

FIG. 8c illustrates an exemplary process for launching widgets in a multimedia center application including widgets.

FIG. 8d illustrates an exemplary process for associating widgets with content displayed by a multimedia center application.

FIG. 8e illustrates an exemplary process for displaying real-time information using a widget in a multimedia center application

FIG. 8f illustrates an exemplary process for providing live chat sessions using widgets in a multimedia center application.

FIG. 8g illustrates an alternative process for providing live chat sessions using widgets in a multimedia center application.

FIG. 9 is a flow diagram of an exemplary display process.

### DETAILED DESCRIPTION

### Hardware Architecture

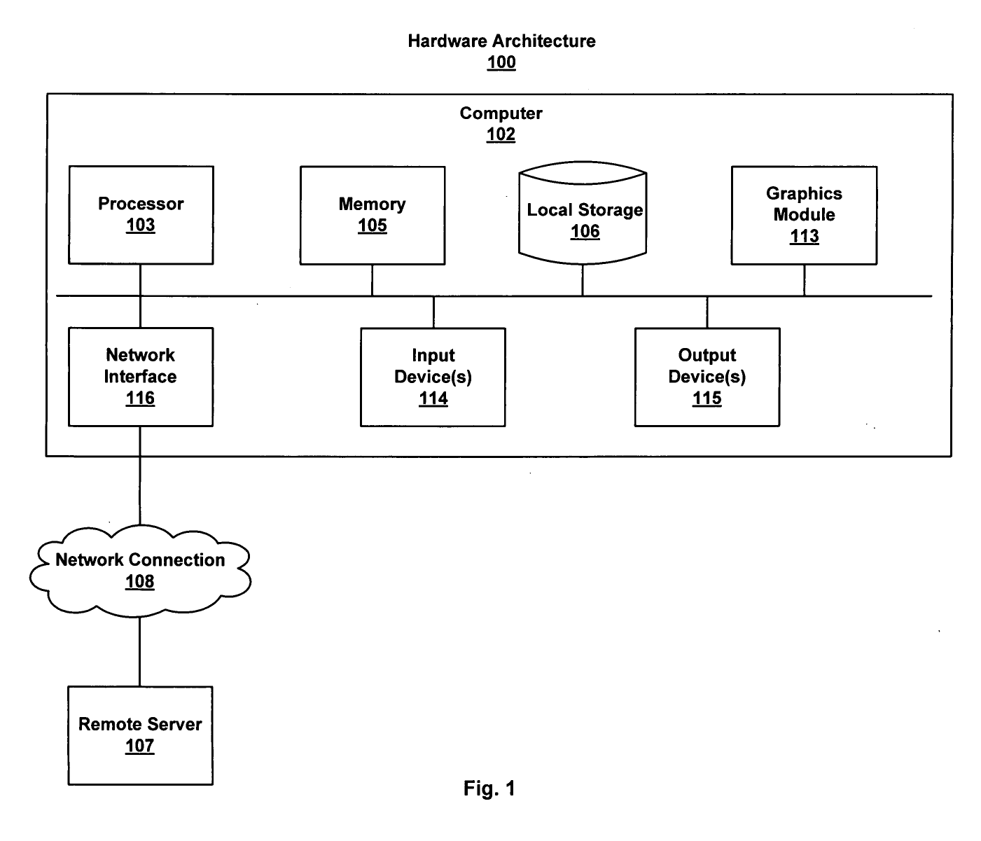

FIG. 1 is a block diagram of a hardware architecture 100 for implementing a multimedia center application including widgets. The architecture 100 includes a personal computer 102 coupled to a remote server 107 via a network interface 116 and a network connection 108 (e.g., local area network, wireless network, Internet, intranet, etc.). The computer 102 generally includes a processor 103, memory 105, one or more input devices 114 (e.g., keyboard, mouse, etc.) and one or more output devices 115 (e.g., a display device). A user interacts with the architecture 100 via the input and output devices 114, 115.

The computer 102 also includes a local storage device 106 and a graphics module 113 (e.g., graphics card) for storing information and generating graphical objects, respectively. The local storage device 106 can be a computer-readable medium. The term “computer-readable medium” refers to any medium that participates in providing instructions to a processor for execution, including without limitation, non-volatile media (e.g., optical or magnetic disks), volatile media (e.g., memory) and transmission media. Transmission media includes, without limitation, coaxial cables, copper wire, fiber optics, and computer buses. Transmission media can also take the form of acoustic, light or radio frequency waves.

While dashboards and widgets are described herein with respect to a personal computer 102, it should be apparent that the disclosed implementations can be incorporated in, or integrated with, any electronic device that is capable of using widgets, including without limitation, portable and desktop computers, servers, electronics, embedded devices, tablets, multimedia players, game consoles and devices, mobile phones, email and instant messaging devices, personal digital assistants (PDAs), set-top boxes, televisions, etc.

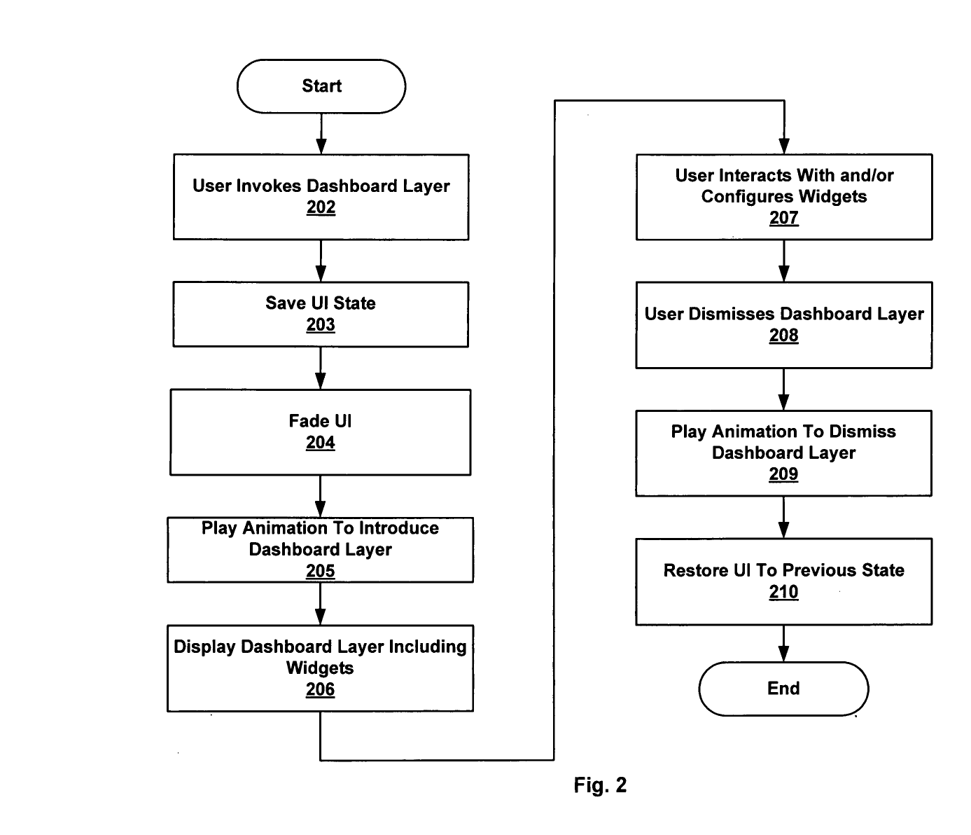

A multimedia center application including widgets can be implemented as one or more plug-ins that are installed and run on the personal computer 102 or other device. The plug-ins are configured to interact with an operating system (e.g., MAC OS® X, WINDOWS XP, LINUX, etc.) and to perform the various dashboard and widget functions, as described with respect of FIGS. 2-9. A multimedia center application including widgets can also be implemented as one or more software applications running on the computer 102 or other device. In some implementations, a multimedia center application including widgets can be another widget that is configurable to communicate with other widgets, applications and/or operating systems. A multimedia center application including widgets can also be characterized as a framework or model that can be implemented on various platforms and/or networks (e.g., client/server networks, stand-alone computers, portable electronic devices, mobile phones, etc.), and/or embedded or bundled with one or more software applications (e.g., email, multimedia player, browser, etc.).

### Dashboard Overview

FIG. 2 is a flow diagram of an implementation of a process for activating and using a dashboard. A dashboard layer (also referred to herein as a “unified interest layer” or “dashboard”) is used to manage and display widgets. A user can invoke a dashboard (202) by hitting a designated function key or key combination, or by clicking on an icon, or by selecting a command from an onscreen menu, or by moving an onscreen cursor to a designated corner of the screen. In response to such user input, the current state of the user interface is saved (203), the user interface is temporarily inactivated (204), an animation or effect is played or presented to introduce the dashboard (205) and the dashboard is displayed with one or more widgets (206). If applicable, a previous state of the dashboard is retrieved, so that the dashboard can be displayed in its previous configuration. In some implementations, the user interface and dashboard are active at the same time.

In some implementations, the dashboard is overlaid on an existing desktop user interface (UI). When the dashboard is activated, the existing UI may be faded, darkened, brightened, blurred, distorted, or otherwise altered to emphasize that it is temporarily inactivated. The existing desktop may or may not be visible behind the dashboard. The desktop can also be shrunk to a small portion of the display screen while the dashboard is active, and can be re-activated by clicking on it. In some implementations, the desktop is shrunk and presented as a widget. The desktop can be re-activated by clicking on the widget.

The user interacts with and/or configures widgets as desired (207). In some implementations, the user can move widgets around the screen, and can resize widgets if applicable. Some widgets are resizable and some have a fixed size. A widget author can specify whether a widget can be resized. Some widgets can automatically resize themselves based on the amount or nature of the data being displayed. Widgets can overlap and or repel one another. For example, if the user attempts to move one widget to a screen position occupied by another widget, one of the widgets is automatically moved out of the way or repelled by the other widget.

The user can dismiss the dashboard (208) by invoking a dismissal command, which causes the normal UI to return or re-present itself to the display screen. In some implementations, the dashboard can be dismissed when the user presses a function key or key combination (which may be the same or different than the key or combination used to activate the dashboard), or clicks on a close box or other icon, or clicks on negative space within the dashboard (e.g., a space between widgets), or moves an onscreen cursor to a predefined corner of the screen.

In some implementations, the dashboard can be automatically dismissed (i.e., without user input) after some predetermined period of time or in response to a trigger event. An animation or other effect is played or presented to provide a transition as the dashboard is dismissed (209). When the dashboard is dismissed, the current configuration or state of the widgets (e.g., position, size, etc.) can be stored, so that it can be retrieved the next time the dashboard is activated. In some implementations, an animation or effect can be played or presented when re-introducing the UI. The UI can be restored to its previous state (210) so that the user can resume interaction with software applications and/or the computer operating system.

In some implementations, the dashboard can be configurable. The user can select a number of widgets to be displayed, for example, by dragging the widgets from a configuration bar (or other user interface element) onto the dashboard. The configuration bar can include different types of widgets, and can be categorized and/or hierarchically organized. In some implementations, in response to the user dragging a widget onto the configuration bar, the widget is downloaded from a server and automatically installed (if not previously installed). In some implementations, certain widgets must be purchased, so the user is requested to provide a credit card number or some other form of payment before the widget is installed on the user's device. In some implementations, widgets are already installed on the user's device, but are only made visible when they have been dragged from the configuration bar onto the dashboard. The configuration bar is merely an example of one type of UI element for configuring the dashboard. Other configuration mechanisms can be used, such as an icon tray or menu system.

It should be apparent that there are many ways in which dashboards and widgets can be displayed other than those implementations described herein. For example, dashboards and widgets can be displayed on any user interface or user interface element, including but not limited to desktops, browser or application windows, menu systems, trays, multi-touch sensitive displays and other widgets. Additionally, widgets and dashboards can be displayed on any surface capable of displaying widgets and dashboards, such as projections onto surfaces, holograms, surfaces of consumer appliances (e.g., refrigerator doors) and the like.

### Software Architecture

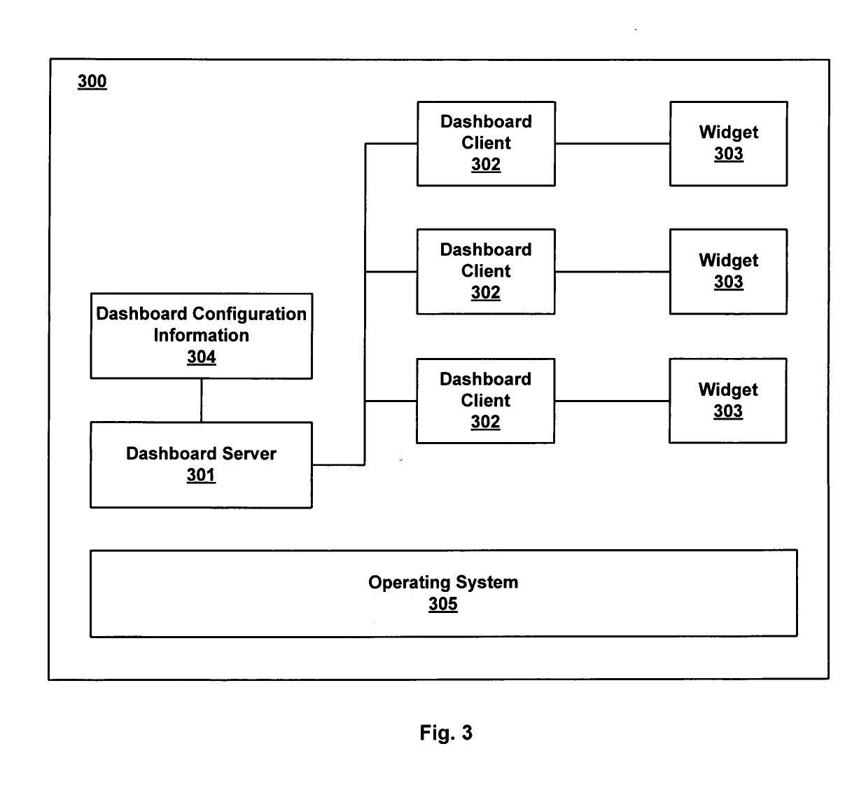

FIG. 3 is a block diagram of a software architecture 300 for implementing a multimedia center application including widgets. The software architecture 300 generally includes a dashboard server 301, one or more dashboard clients 302, and one or more widgets 303. The server 301 and/or clients 302 use dashboard configuration information 304 to specify configuration options for displaying the widgets 303, including access levels and the like (if applicable). Such configuration information can include information for two or more dashboards configured by the same user or by different users.

In some implementations, the widgets 303 can be displayed using HTML and related web technology. The dashboard server 301 manages and launches the dashboard client 302 processes. Each dashboard client 302 loads a widget 303 (e.g., an HTML webpage) and related resources needed to display the page. In some implementations, the dashboard clients 302 display the widgets 303 without a conventional window frame, menu bar, or other components typically associated with on-screen windows. This technique provides a clean, straightforward display of the overall dashboard to reduce confusion and clutter. The dashboard clients 302 can display their respective widgets 303 by rendering web pages into a “WebView,” as described in U.S. patent application Ser. No. 11/148,010, entitled “Preview and Installation of User Interface Elements in a Display Environment.” The size of each WebView can be defined as metadata associated with the corresponding widget 303. The server 301 provides data for rendering a separate layer that can be overlaid on a user interface. The widgets 303 can be rendered into the separate layer which is drawn on top of the user interface (e.g., a PC desktop), so as to partially or completely obscure the user interface while the dashboard is active.

### Dashboard Server

The dashboard server 301 can be a stand-alone process or embedded in another process. The server 301 can be located at the computer 102 or at the remote server 107. In some implementations, the server 301 provides functionality for one or more processes, including but not limited to: non-widget UI management, window management, widget and dashboard management, fast login, event management, loading widgets, widget arbitration, Core Image integration and widget preference management, as described in U.S. patent application Ser. No. 11/148,010, entitled “Preview and Installation of User Interface Elements in a Display Environment.”

### Dashboard Client

In some implementations, a dashboard client 302 can be a process that uses, for example, objects that are defined as part of a development environment, such as Apple Computer's Cocoa Application Framework (also referred to as the Application Kit, or AppKit) for the Mac OS® operating system. In some implementations, the dashboard clients 302 can be implemented as simplified browser screens that omit conventional interface features such as a menu bar, window frame, and the like.

### Widget Format

In one implementation, each widget 303 is implemented as an HTML file. The HTML file can reference other local and remote resources such as style sheets (e.g., Cascading Style Sheets), other HTML files, JavaScript files, images, and the like. Widgets 303 can be implemented using, for example, a flat bundle file format or a packaged HTML file format. In some implementations, the Flat Bundle format includes an info.plist file.

The Info.plist files describes a widget 303 and provides an identifier for a widget 303. Table I provides an example of Info.plist file contents.

TABLE I
Example of Info.plist File Contents

| Key | Type | Description/Value |
|---|---|---|
| CFBundleIdentifier | CFString | com.apple.widget |
| | | <widget name> |
| CFBundleName | CFString | Name of the widget. |
| MainHTML | CFString | Name of main HTML |
| | | resource. |
| Width | CFNumber | Default width of the |
| | | widget. |
| Height | CFNumber | Default height of the |
| | | widget. |
| DefaultImage | CFString | Resource name of |
| | | default PNG file. |
| Plugin (optional) | CFString | Resource name of |
| | | native plug-in. |
| AllowFileAccessOutsideofWidget | Boolean | Access to files across |
| | | the file system; limited |
| | | by the users |
| | | permissions. |
| AllowFullAccess | Boolean | Access to the file |
| | | system, Web Kit and |
| | | standard browser |
| | | plug-ins, Java applets, |
| | | network resources, |
| | | and command-line |
| | | utilities. |
| AllowInternetPlugins | Boolean | Access to Web Kit and |
| | | standard browser |
| | | plug-ins. |
| AllowJava | Boolean | Access to Java applets. |
| AllowNetworkAccess | Boolean | Access to any |
| | | resources that are not |
| | | file based. |
| AllowSystem | Boolean | Access to command- |
| | | line utilities using |
| | | widget script object. |

The keys AllowFileAccessOutsideofWidget, AllowFullAccess AllowInternetPlugins, AllowJava, AllowNetworkAccess, and AllowSystem are Boolean types that can be set by a widget author to enable certain levels of resource access.

### Dashboard Invocation

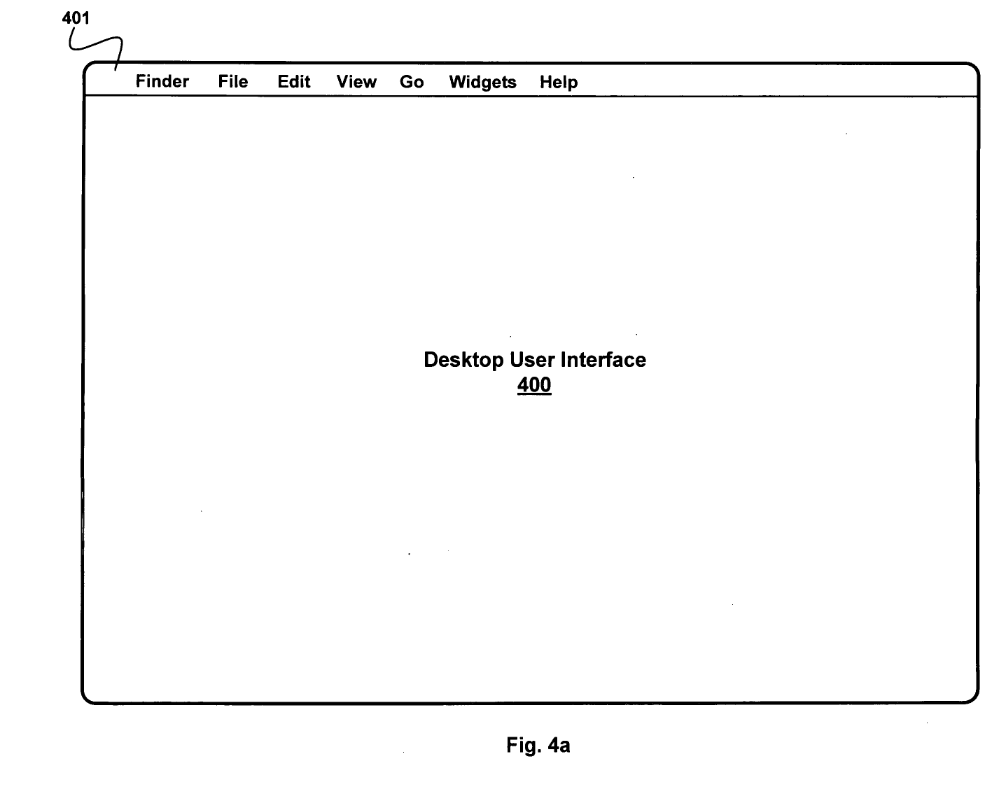

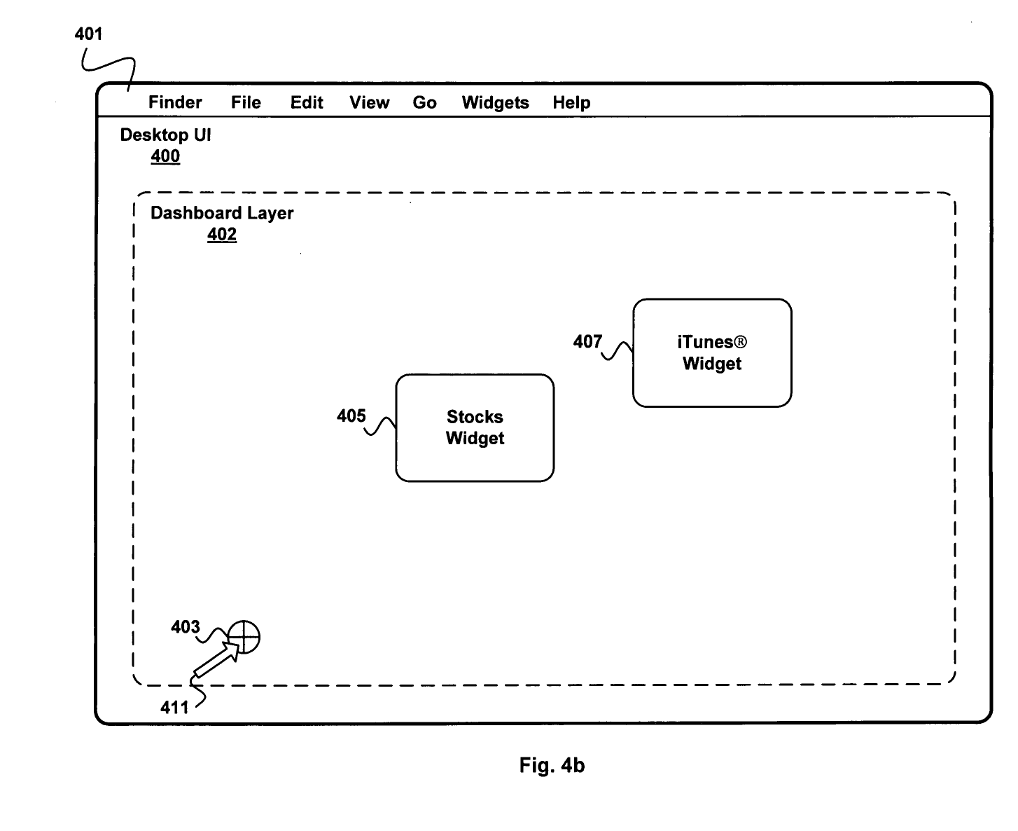

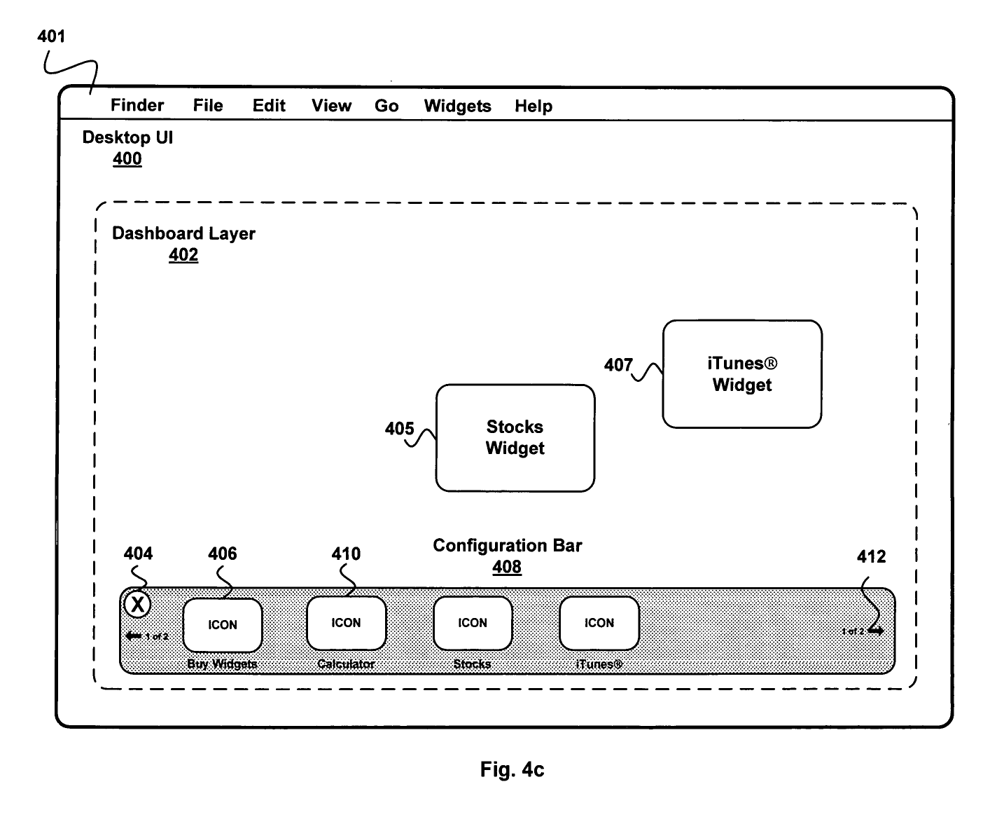

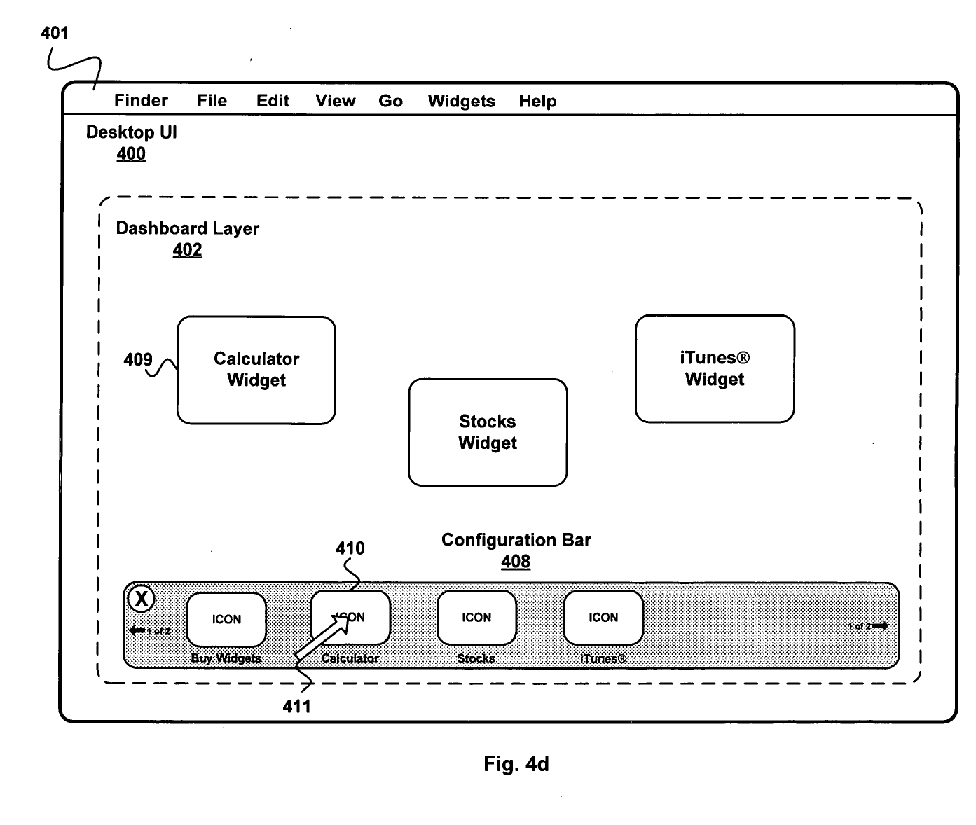

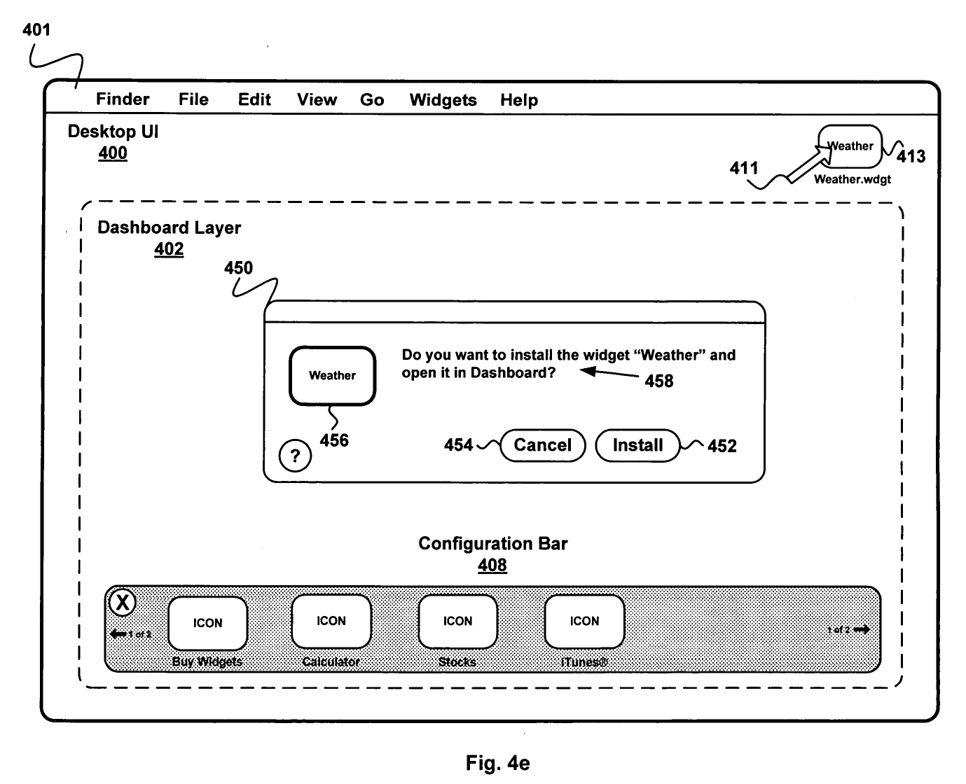

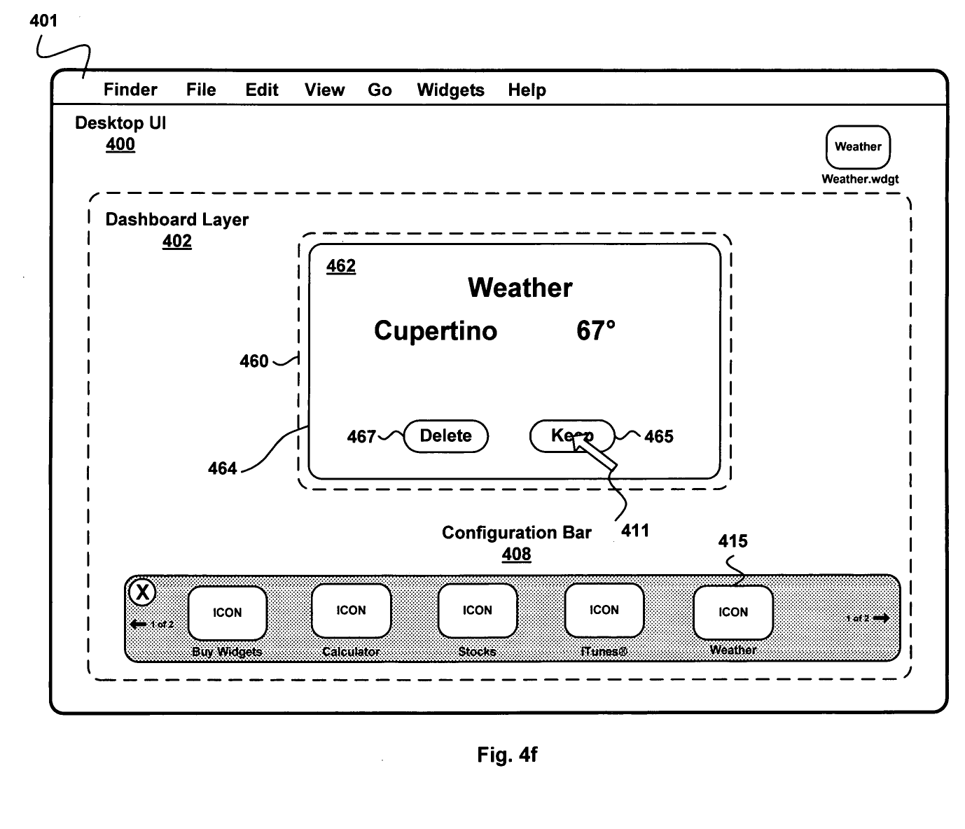

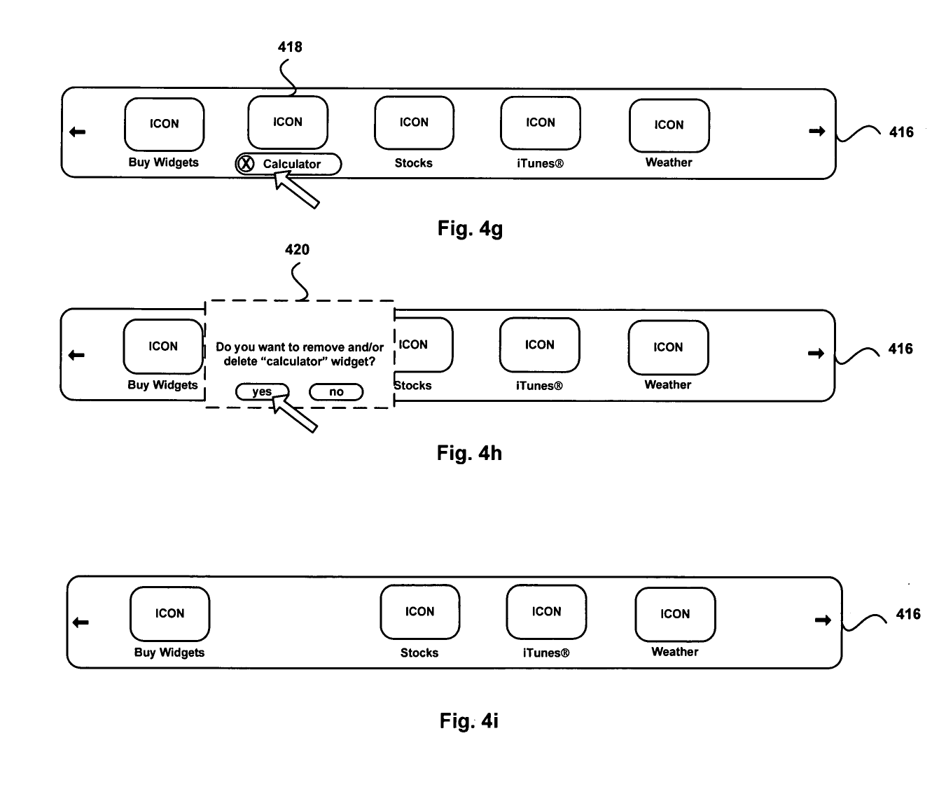

FIG. 4a depicts a user interface 400 prior to activation of a dashboard (e.g., a desktop user interface). The user interface 400 is a conventional user interface as may be provided by an operating system, such as Mac OS®. The user interface 400 has a background image, menu bar 401, and other standard features. As is known in the art, the user interface 400 may also include windows, icons, and other elements (not shown). The user activates the dashboard by selecting an item from a menu, or by clicking on an icon, or by pressing a function key or key combination, or by some other means for invoking activation.

FIG. 4b depicts an initial state for a dashboard layer 402. In some implementations, a configuration bar icon 403 is initially displayed. Alternatively, upon activation the dashboard layer 402 can display one or more default widgets 405, 407. If the dashboard layer 402 has previously been activated and configured, the widgets 405, 407, can be displayed as previously configured. As shown in FIG. 4b, the dashboard layer 402 is not necessarily visible as a distinct layer. However, its various components (such as widgets, icons, and other features) are visible. In some implementations, these components are displayed in a transparent layer, thus maintaining the visibility of the user interface 400 to the user. In some implementations, the user interface 400 and its components are darkened (or blurred, or otherwise visually modified) while the dashboard layer 402 is active, so as to emphasize that the user interface 400 is temporarily inactive. In other implementations, the user interface 400 is not visible while the dashboard layer 402 is active. The user can reactivate the user interface 400 and dismiss the dashboard layer 402 by clicking on an area of the screen where no dashboard element is displayed (i.e., “negative space”). In some implementations, other commands, key combinations, icons, or other user input can be used to dismiss the dashboard layer 402.

In some implementations, the user can drag the icon 403 to any location on the screen, and the position of the icon 403 will remain persistent from one invocation of the dashboard layer 402 to the next. The user can click on the icon 403 to activate the configuration bar 408, as shown in FIG. 4c. The configuration bar 408 provides access to various widgets that can be placed on the dashboard. In some implementations, a text label is shown for each available widget (e.g., calculator, stocks, iTunes®, etc.). In some implementations, an icon is shown for each available widget (e.g., calculator icon 410). If many widgets are available, the widgets may be arranged hierarchically by type (e.g., game widgets, utility widgets, etc.), or alphabetically, or by any other categorization methodology. For example, a number of categories may be displayed, and clicking on one of the categories causes a pull-down menu to be displayed, listing a number of widgets in that category. In some implementations, a buy widget 406 is also available, allowing the user to select widgets from an online store or website.

Note that the particular configuration and appearance of configuration bar 408 in FIG. 4c is merely exemplary, and that many other arrangements are possible. For example, widgets can be installed from other locations, other applications or other environments, without requiring that they first be part of the configuration bar 408. The user can dismiss the configuration bar 408 by clicking on dismissal button or icon 404.

### Alternative Implementation of Configuration Bar

FIGS. 4g-4i illustrate an alternative implementation for deleting a widget from a configuration bar 416. For example, when a user moves a cursor onto the “calculator” label (e.g., a mouse-over) associated with a calculator widget 418, the label is highlighted or otherwise altered, and a delete mechanism (e.g., a delete button) is displayed. If the user clicks or otherwise invokes the delete mechanism, a confirmation overlay 420 is displayed asking the user to confirm the removal and/or deletion of the “calculator” widget. In some implementations, the confirmation overlay 420 is semi-translucent. If the user requests deletion (e.g., clicking the “yes” button), then the calculator widget 418 is removed from the configuration bar 416, as shown in FIG. 4i.

### Installation of Elements

Elements, including user interface elements such as widgets can be installed in a display environment as discussed below. One display environment, a dashboard, will be used for illustrative purposes. Installation can include a preview operation as is discussed below. Installation can include selection of the element, such as by a drag and drop action. Other selection means can be used. In one example, a user can drag widgets from configuration bar 408 onto the surface of the dashboard (in other words, anywhere on the screen), using standard drag-and-drop functionality for moving objects on a screen.

FIG. 4d depicts the selection of the calculator widget icon 410 from the configuration bar 408. The calculator icon 410 which is associated with a calculator widget 409 is highlighted, or otherwise augmented or embellished, to indicate that it has been selected by a user with cursor 411.

In some implementations, widgets in the configuration bar 408 are smaller than their actual size when installed. When the user clicks on a widget and begins to drag it into a dashboard or other display environment, the widget is animated to its actual or installed size to assist the user in the real-time layout of the dashboard. By animating the widget to its actual size, the user will know the actual size of the widget prior to its installation.

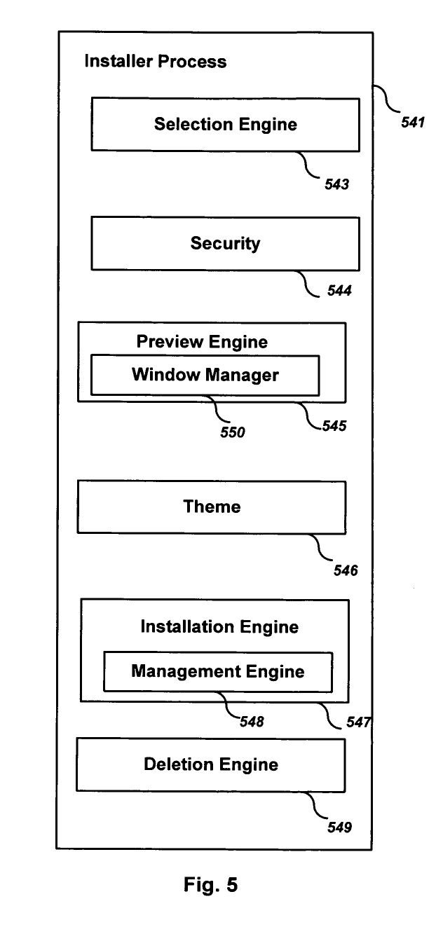

In some implementations, an animation, such as a ripple animation, is shown when the user “drops” a widget by releasing a mouse button (or equivalent input device) to place a widget at the desired location. In one implementation, the dragging of the widget to the dashboard layer 402 invokes an installation process for installing the widget including previewing. After installation, the user can move a widget, to any other desired location, or can remove the widget from the screen, for example by dragging it off the screen, or dragging it back onto the configuration bar 408, by invoking a remove command, disabling a widget in a menu associated with a widget manager or canceling the installation during the preview, as described with respect to FIGS. 5, 6 and 7. In some implementations, the position, state, and configuration of a widget are preserved when the dashboard layer 402 is dismissed, so that these characteristics are restored the next time the dashboard layer 402 is activated.

In some implementations, widgets and/or dashboard layers (including widgets) can be installed from within a running application. For example, a widget and/or dashboard (including widgets) can be an attachment to an email. When the user clicks the attachment, an installation process is invoked for the widget and/or dashboard which can also include a preview.

Widgets can be created or instantiated using an installer process. The installer process can include a separate user interface or an integrated user interface (e.g., integrated in the display environment or separate from the display environment, for example, in another display environment associated with another application, such as an email application) for selecting and installing widgets in a display environment. For example, a widget received as an email attachment can be launched by a user from directly within a user interface of the email application.

Widgets can be created or instantiated using an installer process. The installer process can include a separate user interface or an integrated user interface (e.g., integrated in the display environment or separate from the display environment for example in another display environment associated with another application, such as an email application) for selecting and installing widgets in a display environment. Thus, the installation area for the widget can be embedded within an application display area or window. For example, if a user receives a widget as an attachment to an email, the user can invoke and install the widget from within the email message window without the need for a separate installation window.

In general; an installer process is used to provide additional functionality to the creation/instantiation process, beyond the simple drag and drop operation describe above. Additional functionality can include preview, security and deletion functionality in a singular interface. The installer process can be a separate process or combined in another process. The installer process can itself be a separate application that is executable to install widgets (or other elements) in a display environment. As used herein, the term “process” refers to a combination of functions that can be implemented in hardware, software, firmware or the like.

### Installer Process Engines

FIG. 5 is a block diagram of an installer process 500 for installing widgets in a display environment, including a selection engine 543, a security engine 544, a preview engine 545, a theme engine 546, an installation engine 547, and a deletion engine 549.

### Selection Engine

The selection engine 543 is used to select and present (e.g., a static presentation) a widget for installation. The selection engine 543 can be invoked in a display environment and can produce an installation area (e.g., a dialog, a panel, a window, etc., and hereinafter referred to as an “installation window”), that acknowledges the user's initiation of the installer process. The installation window can include a presentation of a selected widget (or a reference thereto as described below), along with various buttons that may be activated by the user or otherwise to invoke functionality in the installer process.

A screen shot showing an installation window 450 in a user interface is shown in FIG. 4e. Installation window 450 can include one or more interactive features (e.g., buttons) that allow a user to install (e.g., install button 452), or cancel the operation (e.g., cancel button 454). In some implementations, preview is automatic. Alternatively, preview can be selected for enablement prior to installation. Installation window 450 can include a reference 456 and a prompt 458, as described below.

In some implementations, the installation window 450 is invoked by clicking on a widget file or package. For example, a weather widget file 413 (e.g., “weather.wdgt”) can be downloaded to the user's desktop user interface 400 from a web site. When the user double clicks the “weather.wdgt” file with cursor 411, the installation window 450 is displayed in the dashboard layer 402, as shown in FIG. 4e.

In some implementations, a user can select a widget for installation using a remote control device (e.g., infrared device, mobile phone, etc.). For example, a dashboard and/or widgets can be displayed on a display device (e.g., television screen, computer monitor, etc.). The user can use the remote control to select widgets from a menu or configuration bar 408 for installation. The widgets can be displayed in one of multiple resolutions, which is selectable by the user via the remote control. For example, a user can select a widget to be scaled to fit a desired portion of the display device (e.g., full screen).

### Security Engine

The security engine 544 is used to determine a security access level (or risk level, or both) for either the user or the element to be installed. Security engine 544 can be used to limit the ability of the user to install particular kinds of elements (e.g., based on categories or criteria). In addition or alternatively, security engine 544 is used to determine a security access level (or risk level or both) of an element to be installed. Based on the security access/risk level, one or more operational or functional constraints can be placed on the element during the preview process. For example, limitations on the ability of the previewed element to interact, access, read or write data, monitor output of other system resources, access other system resources, or other limitations can be invoked. The invocation can be temporary, for a predetermined time period, or until the preview has terminated and complete (non-limited) installation has been performed. Functionality or operations of the element can be enabled or disabled, depending on the access level. The security engine 544 can use metadata associated with the element to be installed, user input, contextual information, file type information, default data, read/write preferences, cookies and/or other information to determine the access/risk level. Access control lists including white lists (e.g., including lists identifying certified or otherwise safe elements), black lists (e.g., including lists identifying un-certified or otherwise un-safe elements) and the like can be used to determine the access/risk level.

In some implementations, widgets are rated according to their content (e.g., adult content, violence, strong language, etc.). The rating can be determined by the author a third party rating organization. The rating can be used to determine whether a widget will be installed and/or previewed. In some implementations, users can specify which widgets can be installed and/or previewed based on ratings. For example, a parent may specify via a preference pane or other input mechanism that widgets containing adult content ratings will not be installed nor previewed (i.e., parental controls).

In some implementations, widgets are digitally signed by their authors. Digital signatures can be incorporated in files bundled with the widget and can be generated using one or more known digital signature techniques (e.g., key exchange, hashing, message digest, etc.). The digital signature can also be authenticated using a digital certificate issued by a certificate authority using techniques known in the art.

Various techniques for widget security is described in U.S. patent application Ser. No. 11/432,295, for “Widget Security.”

### Preview Engine

The preview engine 545 is used to preview (e.g., dynamically) an element (e.g., a widget) that has been selected to be installed. Referring again to FIG. 4f, the preview engine 545, when invoked, provides an area (hereinafter “a presentation area or presentation window 462” or specifically a “widget window” when used to display a widget) into which the selected element can be displayed. In some implementations, the presentation window 462 is a separate process and embedded within an underlying installer window (i.e., the installation window 460) which, in one implementation, is itself a separate process. In one implementation, the preview engine 545 provides a presentation of a fully functional element/widget in the presentation window 462. The term “fully functional” refers to both the presentation of the widget in terms of size, shape, content and the like along with any supported interactivity features. Alternatively, limitations on the functionality, interactions and the like can be set by the security engine 544 as discussed above. Interactivity can include the separate refreshing of content in the presentation window 462. Alternatively, the content can be static, and only present ornamental properties.

Associated with the preview is a preview designator 464. In one implementation, the preview designator 464 is displayed along with the user interface element being installed (e.g., widget). The preview designator 464 can be of the form of a frame, a carpet on which the presentation window 462 is disposed, a preview theme element, or other designator that overlays, surrounds, bounds or otherwise is associated with the presentation window 462. The preview designator 464 can be a separate process and embedded within an underlying installer window (e.g., the installation window 460) or the presentation window 462 which, in one implementation, may themselves be a separate process. The preview designator 464 is provided to indicate to a user that the element is being previewed and, as of yet, has not been fully installed in the display environment. Further emphasis can be used to convey this information including by using highlights, emphasis, de-emphasis, effects, transitions and the like. The combination of the presentation window 462 and the preview designator 464 comprise an installation area for the user interface element to be installed. The installation area can be part of the display environment in to which the element is to be installed (e.g., part of the dashboard) or part of a separate display environment (e.g., part of another user interface, another user interface element, another application, or process, etc.).

When displaying a fully interactive widget in the presentation window 462, user input can be accepted that can result in changes in the presentation. For example, if the widget includes a URL that is linked to a web page server, interaction can include the generation of an underlying page request and the presentation of the requested page in the presentation window 462. Interaction with user interface elements is described in U.S. patent application Ser. No. 11/145,561, for “Presenting Clips of Content.” If the interaction is not allowed, a display prompt can be shown to indicate that the operation or function is temporarily disabled during the preview operation.

### Window Manager

In some implementations, a window manager 550 is associated with the preview engine 545. The window manager 550 can be a separate process that is used to support the interaction between the presentation window 462, preview designator 464 and the installation window 460 described above. In some implementations, the logic associated with the window manager 550 can be implemented in a same or separate process from the installer process or the preview process. In some implementations, the window manager 550 controls the interaction of the respective windows. Specifically, three separate interactions can be controlled.

First, in some implementations, each window is a separate process displayed and brought forward (in a window hierarchy) together. The bringing together of the multiple distinct windows, each associated with separate processes can be controlled by the window manager 550.

Second, in some implementations, the presentation window 462, preview designator 464 and the installation window 460 are required to interact with each other in predefined ways. For example, the presentation window 462, preview designator 464 and the installation window 460 need not only to be brought forward together, they must also be controlled when interactions are required for the windows once displayed. For example, if one window is moved, i.e., using a drag and drop operation, the multiple windows are managed so that the presentation remains unified (i.e., the presentation window 462 and preview 464 designator are maintained within the installation window 460, though the installation window 460 was the process that received the user interaction to move). To accomplish such, window manager 550 provides an interface between the windows to allow for the receipt of input in one process and the translation to the other process.

Third, in some implementations the windows must be maintained within operating constraints of each underlying process. For example, when one window is resized (i.e., the installation window 460 is resized), the window manager 550 controls the relative presentation of the other windows (continuing this example, when the installation window 460 is resized, the presentation window 462 and preview designator 464 may be repositioned to be centrally displayed in the installation window 460). Note, this third level of management includes management of process constraints. Process constraints include limitations on the changes that can be performed within the context of the installer process for any of the windows. For example, a minimum size constraint can be associated with the underlying presentation window 462, such that resizing of the associated installation window 460 can be constrained to not be so small as to be unable to present the minimum sized presentation window 462 in the newly downsized installation window 460.

The preview engine 545 is responsive to an initiation signal/action and provides the display of the selected widget in a presentation window 462 as described above (see FIG. 4f). Associated with the presentation window 462 can be one or more input mechanisms (e.g., buttons) that allow a user to continue in the installation process (e.g., a keep or install button 465), or cancel the installation process (e.g., delete button 467). In some implementations, if the installation process is cancelled, the presentation process terminates and returns control to the prior operative environment (i.e., return to the initiating point, for example, reinitiating the selection process).

In some implementations, the installer process does not include or allow for the selective bypassing of the preview presentation (e.g., bypass preview or does not include the preview engine 545). In some implementations, the preview engine 545 is itself a separate process or application (e.g., can be separate from the installer process 541). In some implementations, the preview engine 545 is itself a user interface element (e.g., a preview widget) that can be used to preview widgets prior to installation, deployment, instantiation, or the like.

### Theme Engine

Theme engine 546 is operative to provide additional content to accompany the content displayed in the presentation window or installation window. The theme engine 546 is operative to determine a theme to be associated with an item to be installed (e.g., a widget), identify additional content for concurrent display, and facilitate the display of the additional content. Additional content can be of the form of a frame that is used to bound the item to be installed on one or more sides. Examples of additional content include a picture frame, a content player (e.g., a video player, a still image player, etc.). The additional content can be static or include functional elements (e.g., buttons, for example to play content). Alternatively, the additional content can be displayed in an overlay or other overlapping manner, be a separate process or window or be part of the presentation window. The additional content can be stored or retrieved as required. The identification of the additional content by the theme engine 546 can be based on meta-data that accompanies the item to be installed, based on an analysis of the item to be installed, automatically defined based on file type (e.g., all .pic files are provided a picture frame, or all preview files are provided with a preview frame). Themes can be assigned by a user after receipt or prior to transfer to a receiving party.

### Installation Engine

The installation engine 547 is operative to install/instantiate the selected widget in the display environment. The installation engine 547 can copy or move as required the selected widget to an appropriate volume and store the data structures (including preference data, identification data, scripts, navigation data and the like) for use in the display environment. In some implementations, the installation engine 547 includes an automatic invocation of the underlying display environment with the installed user interface element presented (i.e., the installation engine 547 installs the widget in, and opens up, a dashboard including the installed widget in a preview mode).

### Deletion Engine

The deletion engine 549 provides control for widgets after installation. The deletion engine 549 can be a separate process from the installer process 541, or included therein. The deletion engine 549 can receive input and display user interface elements (dialogs and the like) to ensure that deletion operations are effectuated as required. The deletion engine 549 can be responsive to the selection of a user interface element, a portion of the element, controls associated with the element and the like.

In some implementations, the deletion engine 549 receives mouse over input and displays a graphical element associated with a given identified element. The graphical element can include a control that allows for the activation of the deletion engine. The activation can cause the display of a window (e.g., a confirmation window) to ensure appropriate behavior. Other methods for deleting user interface elements are possible. For example, deletion of a user interface element can also be effectuated during the installation process as discussed above. More specifically, a user interface element can be previewed using the preview engine 545, and subsequently deleted prior to full installation.

Deletion can include deactivating a user interface element and leaving its associated files on the host system or device, or deleting the user interface element and removing all its associated files from the host system or device. The user can be prompted to confirm deletion of a user interface element before deletion is initiated.

In some implementations, the installer process 541 is part of a separate process that is not associated with a dashboard layer. Alternatively, the installer process 541 can be part of a dashboard application and be activated, by for example, by selecting a widget for addition to the dashboard layer. Selection can include for example double clicking on a widget displayed in a configuration bar 408 (shown in FIG. 4c). Other installation tools are possible. For example, a widget bar (not shown) can be used to display the widgets that are available for installation in a given display environment. The widget bar can be part of an authoring application for the creation of widgets, or be selectively activated. Alternatively, the installer process 541 can be separately called, with the destination of the widget being defined as part of the application (e.g., into a dashboard layer, a desktop environment, an electronic display device environment, or the like).

### Dashboard Layer

In a dashboard layer, installer process 541 can include a widget bar and an associated installer process. The installer process when invoked can cause the display of the widget bar in the user interface. In one implementation, the dashboard layer itself, as currently configured can also be displayed when the installer process is invoked. The installer process can then be invoked to select available widgets for installation from the widget bar, preview widgets, or remove installed widgets (e.g., remove widgets from the widget bar) depending on the configuration of the installer process.

### Desktop Environment

In a desktop environment, installer process 541 can be of the form of an installer application that can be invoked (automatically, by the user, by the operating system, by an application or other invocation tool) to present user interface elements that are available to be installed in the desktop environment. The installer application can include a user interface element bar and an associated installer process. The installer process when invoked can cause the display of the user interface element bar in the user interface. The installer process can then be invoked to select available user interface elements for installation from the user interface elements bar, preview user interface elements, or remove installed user interface elements (i.e., remove user interface elements from the user interface elements bar) depending on the configuration of the installer process.

### Installation Process

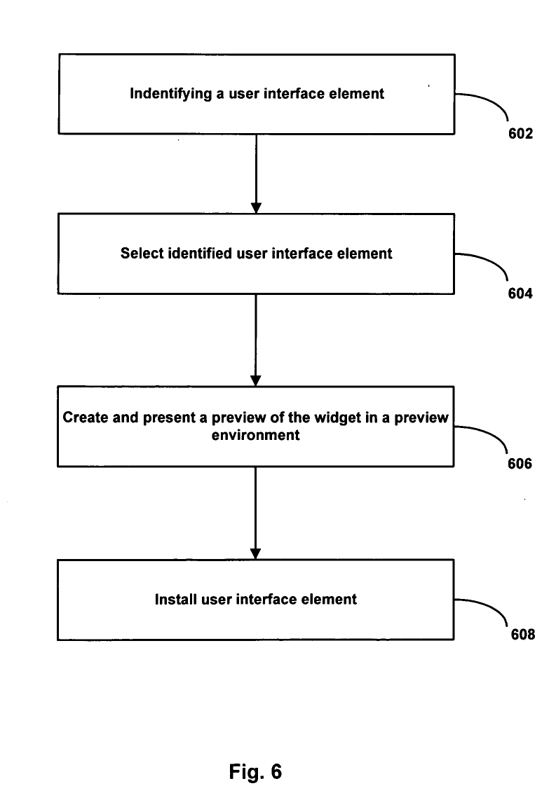

FIG. 6 is a flow diagram of a process for installing a user interface element (e.g., a widget) in a display environment. The process includes identifying a user interface element (602). Identifying the user interface element can include locating a widget. Locating can include using a search tool or the like to locate widgets available for installation. Alternatively, other methods can be used for identifying user interface elements for installation including automatic and user controlled identification methods.

After identification, the identified user interface element is selected for installation (604). Selecting a user interface element can include selecting a user interface element from a configuration bar (e.g., configuration bar 408), a widget bar, a tool bar, a menu, an authoring application, or other source. Alternatively, selecting can include dragging or dropping the user interface element onto a display environment (e.g., a dashboard layer), downloading the user interface element from a content source or other source, or other selection process. Selecting can include launching an associated installation process for installing the user interface element, a preview application for previewing the user interface element prior to installation or other application including authoring applications. The launching of the applications can be automatic or user or otherwise selectively controlled.

Upon receipt of the selection, an installation window is presented (e.g., installation window 460). In some implementations, the installation window includes a user interface display portion, a prompt, and one or more interactivity elements. The user interface display portion can include a reference, partial display, or complete (e.g., complete but for the ability to interact, a static display) display of the user interface element that has been selected. The reference (e.g., reference 456) can be a complete reference, a pointer, a designator, a still image, or otherwise that identifies the candidate user interface element for installation. In this way, the user is able to recognize that the selection made corresponds to content (e.g., a widget) that the user desires to install.

The prompt can be of the form of a confirmation to the user of the underlying action (e.g., prompt 458). In one implementation the prompt can be used to confirm a desire to install a named widget. In other implementations, the prompt can be used to confirm not only the named user interface element for installation, but the display environment into which the user interface element will be installed (e.g., “Install named widget #1 on my desktop?” or “Install widget #1 on dashboard #1 of 2?”). In still other implementations, the prompt can include a confirmation of an action (e.g., “install the widget and open it in my dashboard”).

The interactivity elements can be of the form of buttons or the like. In one implementation, the installation window includes two interactivity elements including a cancel element (e.g., a cancel button 454), and an installation element (e.g., an installation button 452). Other interactivity elements are possible, including those that link to other associated applications, content sources (e.g., to allow for the selection of a different widget for installation), preview option (e.g., if not automatically previewed) and the like.

Continuing with the method, if a preview option is selected or required (optional), then a preview of the widget in a preview environment is created and presented (606). The creation of the preview environment can include the invocation of a window management engine (e.g., window manager 550) for managing the interaction of one or more windows that make up the preview. In some implementations, the preview includes a presentation window (e.g., presentation window 462) and a preview designator (e.g., preview designator 464) that are separate processes. The presentation window is used to display an instantiation of the selected widget. In some implementations, the display of the presentation window includes an instantiation of the selected widget in a selectable interactive environment. The preview designator is provided to clearly indicate that the preview operation is being performed, as opposed to a conventional direct installation. In some implementations, the preview is presented at a same location in the user interface. Alternatively, if other elements are present at this location, another location or an temporary overlay can be used. In some implementations, the preview designator 464 is a carpet, onto which the presentation window 462 is laid (e.g., layered, overlaid, or the like).

In some implementations, theme content can be presented along with the user interface element in the preview installation window 460. The theme content can include a theme presentation element that operates as the preview designator (e.g., additional content that is recognized as being part of a preview of an item, for example a preview Title or the like). Other theme content can be presented to preview how the final installed version of the user interface element will appear. For example, assuming a theme border is to be presented with the user interface element at installation, the preview can include the same theme border.

Associated with the preview process may be an authoring or selection process. For example, if the preview displayed is not satisfactory to a user (e.g., the theme content is unsatisfactory), an interactivity element can be presented in the user interface to allow the direct launching of another process (e.g., a search process or application, an authoring application, a selection application or other process or application so that a more appropriate/desirable user interface element can be located/installed) with or without terminating the installation process.

Finally, the user interface element can be installed (608). The installation of the user interface element can include the installation on a tool bar (e.g., a widget bar), in a resource, in a widget manager or in a display environment (e.g., directly on a dashboard layer or the desktop). Installation can include the saving of the underlying content metadata including data structures defining the user interface element in a library or the like. Alternatively, the installation can be part of an underlying application (e.g., directly in an associated dashboard application or a library associated therewith). In some implementations, the installation of the user interface element includes the removal of the preview designator. For example, where a carpet is used to designate the preview, the carpet can be removed for the final installation. In one implementation, the final installation is performed at a same location in the user interface as the preview. In some implementations, an animation or other transition effect can be used when moving from preview to final installed user interface elements. Transitions can include the appearance of pulling of the a carpet preview designator from under the user interface element or otherwise making the carpet disappear.

The process steps described can be performed in other orders, repeated or the like to provide desired results. For example, the preview process can be repeated in association with the selection of multiple different user interface elements prior to invoking the installation step.

Once installed, user interface elements can be removed/deleted from the display environment as required. In some implementations, a separate deletion process is provided from the installation process. Alternatively, the installer process can be invoked to remove/delete user interface elements as required.

In some implementations, deletion includes deactivating the widget but the widget remains installed on the system or device. Alternatively, deletion includes removing the widget completely from the system or device. If a request to delete a widget is received in response to a user action (or programmatically by the operating system or another application), then a message providing the user with deletion options can be presented, enabling the user to determine whether the widget will be deactivated and/or removed from the system or device. In some implementations, the system or device executes a default deletion option which can be changed by the user via a preference pane or other input mechanism, or overwritten by an application or other software component or device (e.g., security engine 544).

### Widget Searching

In some implementations, widgets are associated with a widget data type or other metadata to enable a search engine (e.g., Apple's Spotlight® search engine) to search for widgets in files, documents, images, emails, applications, etc. Widgets can be indexed based on data type and/or other metadata. For example, a query can be generated requesting a list of all widgets on a host machine and/or devices on a network. The search engine accesses the index to locate widgets on the host device and/or network devices.

In some implementations, dashboards can be searched by other dashboards and/or a search mechanism (e.g., a search engine) for particular widgets or for other dashboards. For example, a query can be generated programmatically or by user requesting a list of all widgets and/or dashboards related to a particular user interest which are available for access locally or through a network connection.

### Widget Manager

In some implementations, a widget manager allows users to inspect, remove, enable, disable, show and hide widgets. The widget manager can be a preference pane, a standalone application or a plug-in. The widget manager displays widget information, including but not limited to the widget's title, author, version, class, type, ratings, description, etc. The information can be displayed in any order and format according to one or more sorting criteria, such as alphabetical or chronological order, author, class, rating, etc. In some implementations, the widget manager tracks widget updates and automatically notifies the user or host system or device when an update is available.

In some implementations, the widget manager allows users to perform certain actions on widgets, including but not limited to copying, moving, deleting, uninstalling, deactivating, enabling, disabling, renaming, previewing, showing, hiding etc. In some implementations, the widget manager includes functionality that allows the import and export of widgets to and from various widget sources (e.g., network, email, CD ROM, etc.). For example, widgets can be imported and exported to and from a web site that can be accessed by multiple users. In some implementations, the widget manager includes a search field that allows users to search for widgets on a host system or device, and/or one or more networked devices.

In some implementations, the widget manager can be invoked by a button or other input mechanism located in a user interface (e.g., desktop, system tray, dashboard layer, configuration bar, etc.). For example, when the button is activated, the widget manager is launched and a user interface is displayed. In some implementations, the widget manager is a widget itself and includes at least some characteristics, attributes or properties of other widgets. For example, the widget manager can be enabled or disabled, resized, hidden, dragged and dropped, flipped to reveal special options or preferences, etc.

In some implementations, the widget manager can be displayed in a format that is consistent with a dashboard theme or content. The appearance and/or properties of the widget (e.g., colors, styles, fonts, etc.) can be changed by a user via a preference pane or other input mechanism.

### Example User Interface for a Widget Manager

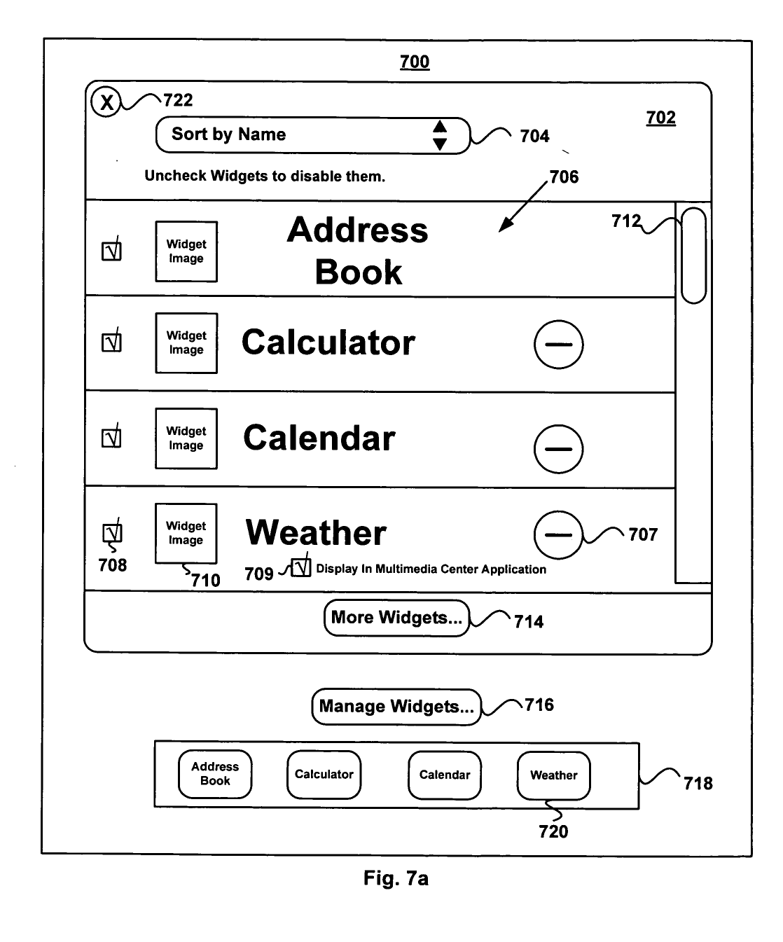

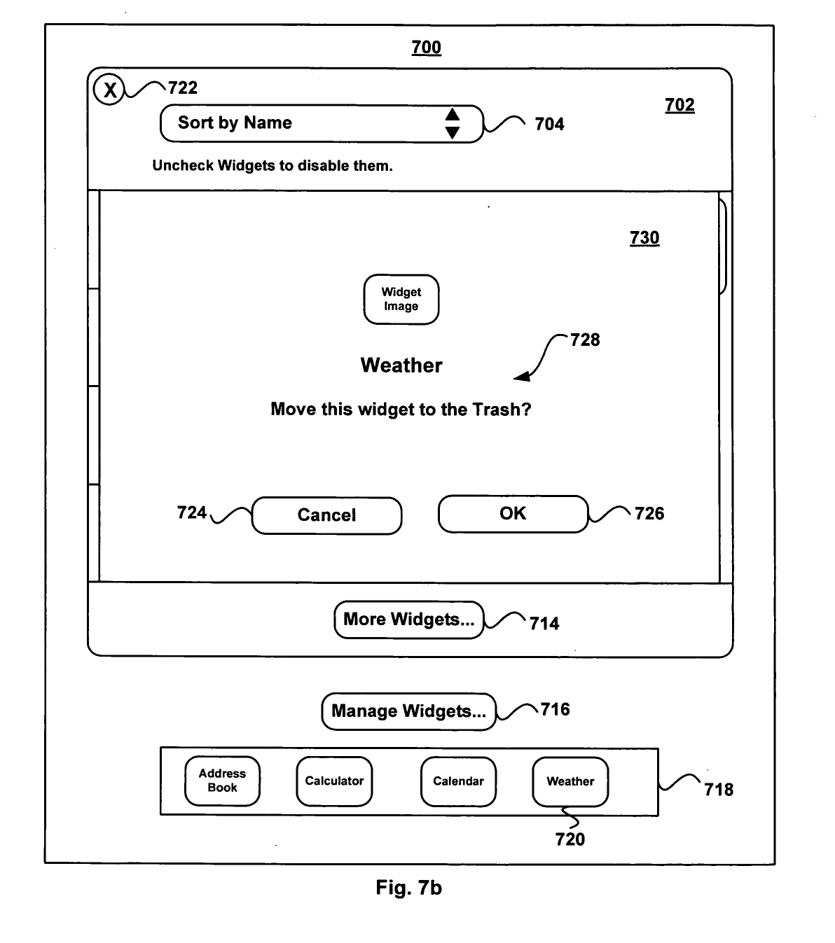

FIG. 7a illustrates a user interface 702 for a widget manager. It should be apparent that a user interface for a widget manager can include more or fewer features than shown.

In some implementations, the user interface 702 is displayed in another user interface 700 (e.g., a desktop or dashboard layer) in response to user input. User input can include, for example, clicking on a button 716 (e.g., a “Manage Widgets” button) or other input mechanism located in the user interface 700. The user interface 702 can be dismissed by clicking on button 722 or other input mechanism.

In some implementations, the user interface 702 includes a scrollable list 706 of widget names and/or other attributes which correspond to widgets that have been installed on the host system. In some implementations, the scrollable list 706 includes widgets that reside on the host system but have not been installed (e.g., widgets downloaded to a desktop). This implementation enables users to install widgets from within the widget manager. In some implementations, the list 706 includes names of widgets that reside on another device coupled to the host system via a network connection. In some implementations, a search history is maintained to enable the user to refine search terms and/or re-run a previous search.

Optionally, next to each widget is an icon image 710 associated with the widget that can assist the user in selecting the widget from the list 706. Widgets that are selected to be hidden (e.g., based on a “hide widget” option provided in the widget manager) will not be shown in the list.

The widgets can be scrolled using, for example, a scroll bar 712. Users can also toggle each widget on and off (i.e., enable/disable the widget) by selecting a checkbox 708 located to the left of each widget listing. Similarly, on the right side of some widget listings is a button 707 or other input mechanism that allows users to delete the widget. Note that for this example, widgets that cannot be deleted do not have a corresponding button 707.

In some implementations, the user interface 702 includes a menu 704 (e.g., located at the top of the user interface 702) of sorting options that will sort the widget list 706 by name, date, author, rating or any other sorting criteria. In some implementations, the menu 704 includes an option to sort widgets based on whether the widgets are enabled or disabled.

In some implementations, a button 714 (e.g., a button labeled “More Widgets . . . ”) or other input mechanism allows a user to search for more widgets located in local directories or on one or more network devices (e.g., a website).

In some implementations, when a widget is enabled (check box 708 is checked) the widget's icon image 720 is displayed in a configuration bar 718 in user interface 700. For example, since the check box 708 associated with the “weather widget” is checked, its icon image 720 is displayed in the configuration bar 718 in user interface 700. Similarly, if the check box 708 is unchecked, then the image icon 720 is not displayed in the configuration bar 718 or its appearance is altered (e.g., grayed out, darkened, made translucent, etc.) to indicate to a user that the widget is disabled.

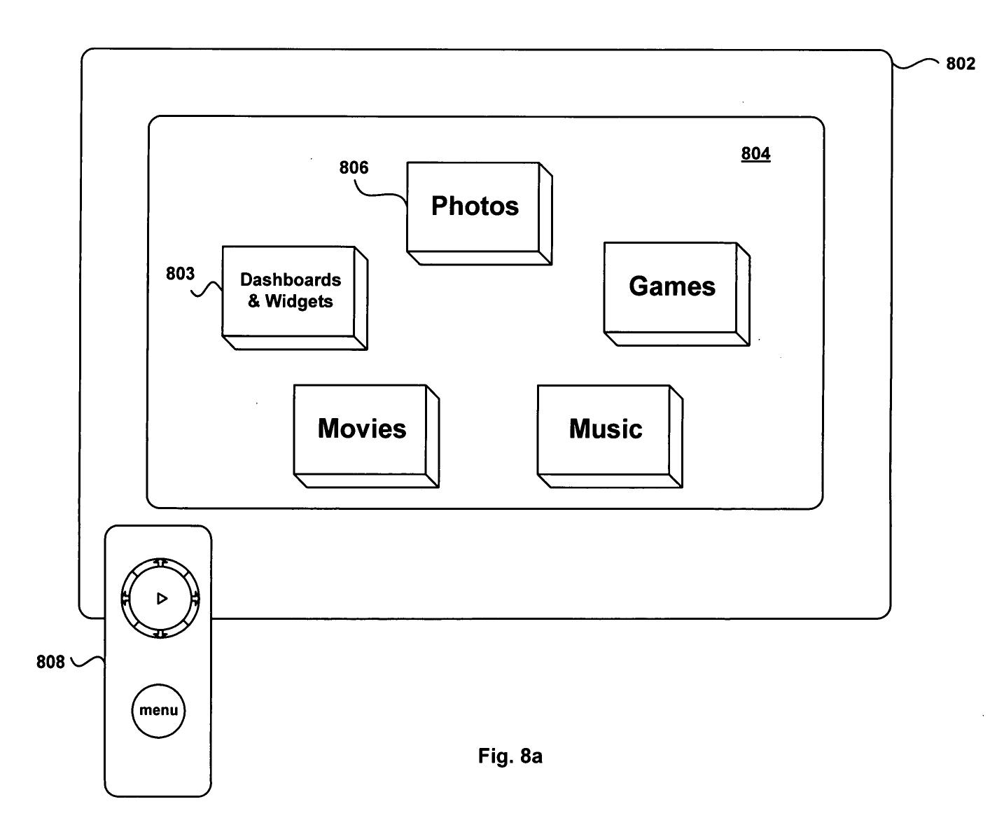

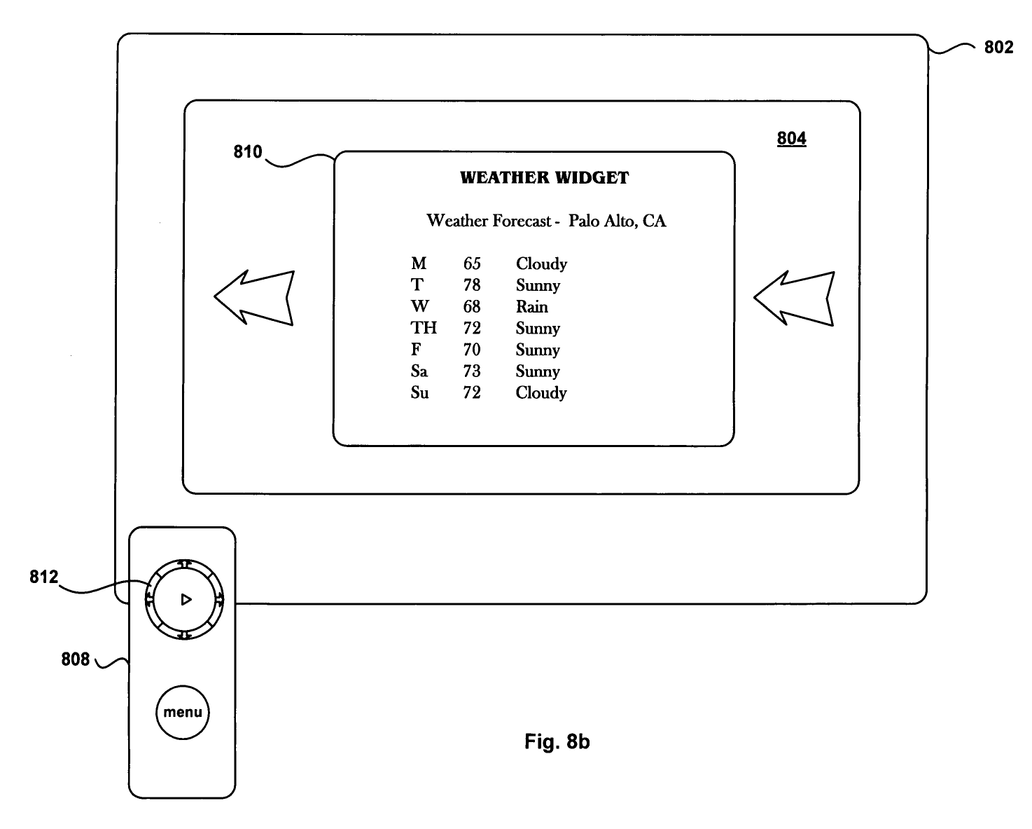

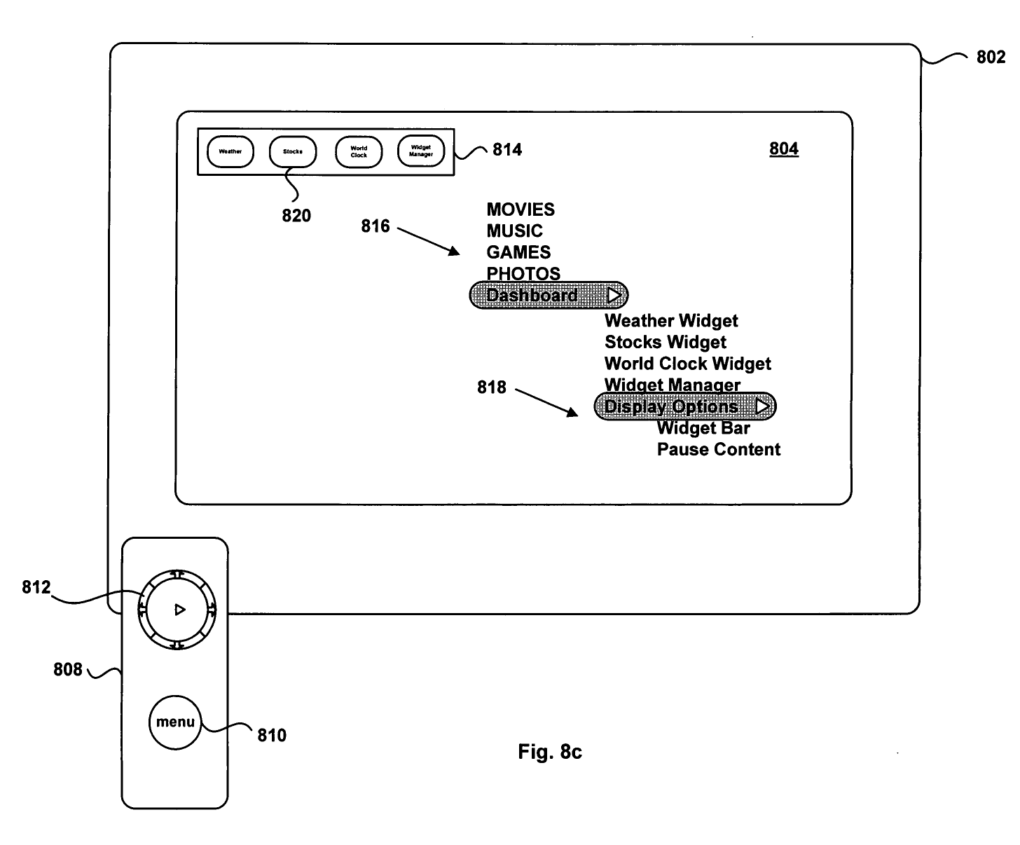

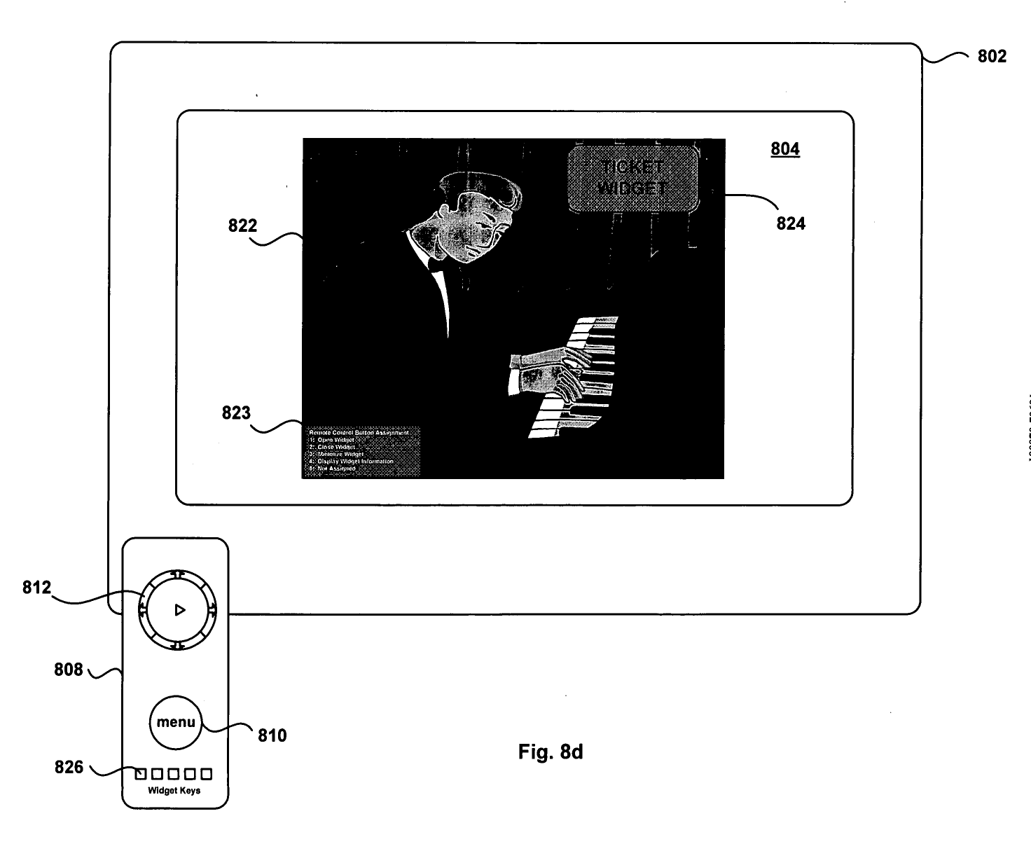

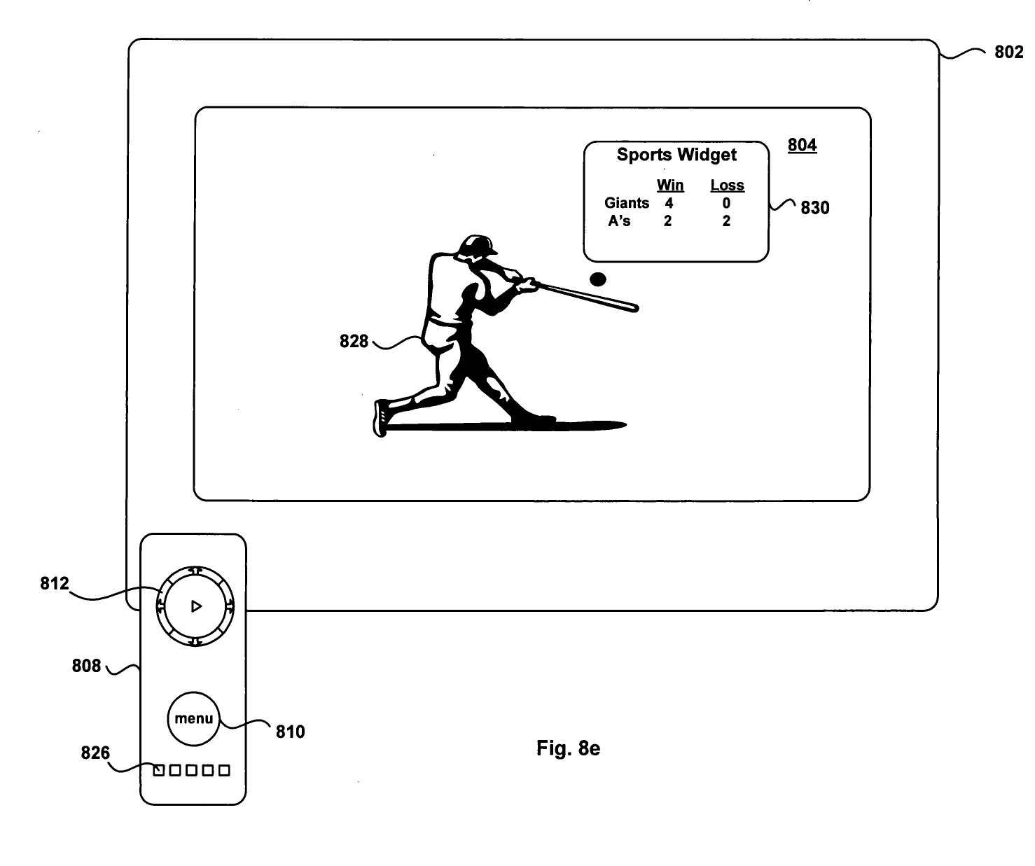

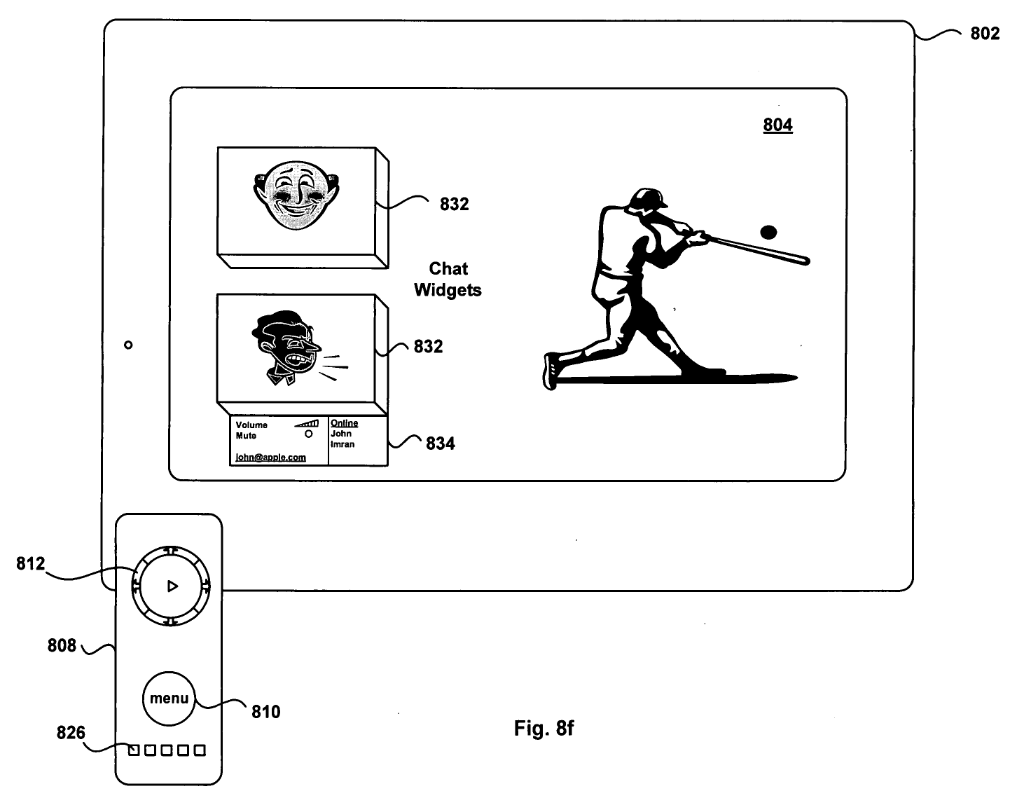

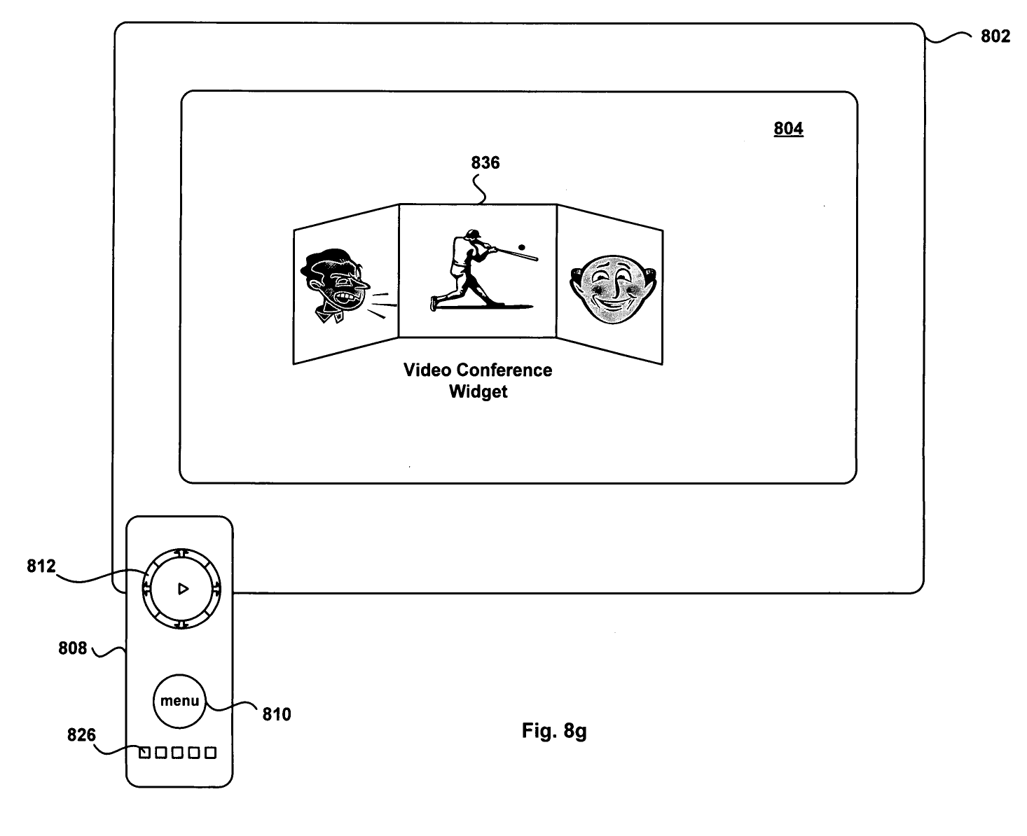

In some implementations, a second checkbox 709 is provided to allow widgets to be displayed in a multimedia center application, as described in reference to FIG. 8a.

FIG. 7b illustrates a widget manager overlay 730 for requesting a user to confirm the deletion of a widget. In some implementations, when clicking the delete button 707 (FIG. 7a), a semi-translucent overlay 730 appears within the user interface 702 including a message 728 requesting the user to confirm their intent to delete the widget. For example, the message 728 could be “Move this widget to the Trash?” The user can respond to the message 728 by clicking a button 726 (“OK”), which results in the widget being moved to the “Trash” or otherwise deleted from the host system. The user can also respond by clicking a button 724 (“Cancel”), which results in the deletion operation being terminated. If a widget is moved to the “Trash” or otherwise deleted, then its icon image 720 is removed from the configuration bar 718.

### Multimedia Center Application Including Widgets

FIG. 8a illustrates an exemplary user interface for a multimedia center application including widgets. A “multimedia center application” is an application that provides users with centralized access to content and applications, including but not limited to: videos, television, music, Internet radio, games, editing tools (e.g., photo editing, DVD authoring), utilities (e.g., Internet phone), etc. Some examples of multimedia center applications include Front Row® developed by Apple Computer, Inc. (Cupertino, Calif.) and Windows® Media Center developed by Microsoft® Corporation (Redmond, Wash.). Users can access the multimedia center application using traditional input devices (e.g., a mouse, keyboard) or with a remote control device (e.g., infrared or radio frequency device). In some implementations, a multimedia center application provides an “entertainment hub” for the home that aggregates the user's entertainment applications onto a single platform (e.g., a personal computer).

In some implementations, the multimedia center application presents a user interface 804 on a display device 802. The display device 802 can be coupled to or integrated with a personal computer (e.g., computer 102), a television, a set-top box, a mobile phone, a game console, a PDA or any other device that can be coupled to or integrated with a display.

A user can manage applications and content (e.g., photos, movies, music, games, etc.) by interacting with user interface elements (e.g., icons, hot spots, menus, etc.) in the user interface 804 using one or more input devices (e.g., mouse, keyboard, remote control, etc.). The user interface 804 includes one or more user interface elements (e.g., icons, menus, buttons, etc.) for each application, which are used to configure, launch and interact with an application. For example, if the user clicks on a photos icon 806 with a mouse, a photo application can be launched. In some implementations, the icons can be an animated to follow a motion path in a three-dimensional (3D) modeled user interface 804. An example of a multimedia center application is described in U.S. patent application Ser. No. 11/249,139, for “Multimedia Control Center.”

In some implementations, the user can interact with the multimedia center application through a remote control device 808 (e.g., infrared, wireless, etc.) In the example shown, the remote control device 808 includes one or more controls (e.g., buttons, dials, wheels, etc.) for interacting with the multimedia center application. An example of a remote control device 808 suitable for interacting with a multimedia center application is the Apple Remote developed by Apple Computer, Inc. (Cupertino, Calif.). Other remote control devices can be used to interact with a multimedia center application, including remote control devices with more or fewer controls, or different controls (e.g., a touch screen).

In some implementations, a multimedia application includes one or more widgets that can be launched or displayed by the user through the user interface 804 using the remote control device 808. For example, widgets can be displayed in the user interface 804 in response to clicking or otherwise interacting with a dashboards & widgets icon 803.

Widgets can be included in the installation of the multimedia center application or other application. Widgets can be included with content that is accessible from the multimedia center application menu system. For example, a Digital Video Disk (DVD) of a movie can include widget files which can be detected and installed by the multimedia center application in response to a trigger event. In some implementations, widget files can be downloaded to the device as part of a television broadcast or through a connection to a network (e.g., an Internet or Ethernet connection, wireless connection, etc.).

Widgets can be tagged for display in a multimedia center application. A “tag” can be a string, flag, number or any other data, which can be stored in widget file or any other location. In some implementations, previously tagged widgets are installed when the media center application is launched. A user can also manually tag a widget for display in a multimedia center application while the multimedia center application is running. For example, a user can manually tag a widget by clicking a check box 709 in the UI 702 of the widget manager described in reference to FIG. 7a. Widgets that cannot be displayed in a multimedia center application can be displayed without a checkbox 709. In some implementations, the widget itself can include an input mechanism (e.g., a button, menu, checkbox, etc.) which is used to tag the widget for display in a multimedia center application.

Widgets can also be automatically tagged for display in a multimedia center application. When a widget is downloaded by a downloading application the widget can be tagged based on a theme associated with the widget or the context in which the widget is downloaded. For example, if the widget is downloaded while the multimedia center application is running, the widget can be automatically tagged for display in the multimedia center application under the assumption the widget was downloaded for such purpose. Other criteria that could be used for tagging widgets are described in U.S. patent application Ser. No. 11/357,730, for “Selection of User Interface Elements for Unified Display In A Display Environment.” In some implementations, widgets can be tagged for display in a multimedia center application by other widgets or applications.

Widgets can be previewed in a multimedia center application prior to installation, such as is described in U.S. patent application Ser. No. 11/282,110, for “Preview Including Theme Based Installation of User Interface Elements In A Display Environment.” Widgets can reside in multiple dashboards in a multimedia center application, such as is described in U.S. patent application Ser. No. 11/346,603, for “Multiple Dashboards.” In some implementations, a multimedia center application can include a widget manager, such as is described in U.S. patent application Ser. No. 11/429,492, for “Management of User Interface Elements In A Display Environment.”

In some implementations, the display device 802 can be large to facilitate viewing movies and other content from a distance. For such display devices, certain widgets installed on the device (e.g., installed in a dashboard layer) can be configured to automatically scale to fit the screen of the display device 802 to facilitate viewing from a distance. Examples of widgets that are suitable for scaling are a world clock widget, a stock widget and a weather widget.

### Displaying Widgets in a Multimedia Center Application

FIG. 8b illustrates an exemplary process for displaying widgets in a multimedia center application. In some implementations, a user can use a remote control device 808 to display a widget. In the example shown, a weather widget is displayed in the user interface 804 of a display device 802 in response to a user interacting with a left arrow button 812. When the user presses the left arrow button 812, the weather widget slides into the user interface 804 from the right. Note that the large arrows in the user interface 804 are for illustrating motion. Other methods for displaying a widget in the user interface 804 are possible, including sliding widgets in from the left or from the top or bottom of the user interface 804. Widgets can also be displayed in the user interface 804 using a variety of transition animations. In some implementations, widgets can be displayed whenever the multimedia center application is in an idle state. For example, if a movie that is playing is “paused” by the user, then widgets could be displayed over the paused content until the user resumes the movie by pressing a “play” button, as described in reference to FIG. 8d. In some implementations, widgets can be displayed after a period of inactivity has transpired. For example, if the multimedia center application is running for a predetermined period of time (e.g., 5 minutes) without user interaction (e.g., no input detected from a remote control device is detected), then a “screensaver” dashboard including widgets can be displayed until a user interaction is detected (e.g., input from a remote control is detected).

In the example shown, the weather widget was displayed because it was the next widget in a widget bar 814 or a menu 816 containing the weather widget, a stocks widget, a world clock widget and a widget manager widget, as shown in FIG. 8c. If the use clicks the left arrow button 812 again, the weather widget would slide off the user interface 804 to the left and the stocks widget would slide onto the user interface 804 from the right, since the stocks widget is next to the weather widget in the widget bar 814 and the menu 816. Thus, the user can cycle through the available widgets by continuously clicking on the left arrow button 812. The user can change the order of widgets in the configuration bar 814 and menu 816 using the remote control device 808 or other input device (e.g., a mouse, keyboard). Widgets can be added and deleted to the widget bar 814 or menu 816 by the user as desired, or in response to a request by an application or operating system.

The user can interact with a widget, such as enabling/disabling features, providing input, setting configurations, etc. Such interactions can be performed using the remote control device 808, alone or in combination with one or more other input devices (e.g., mouse, keyboard, etc.).

### Widget Bar and Menu System

FIG. 8c illustrates an exemplary process for launching or displaying widgets in a multimedia center application. In some implementations, the user interface 804 includes a widget bar 814 which displays widget icons 820. The widget bar 814 can be displayed in the user interface 804 in response to user input. For example, the user can click on a menu button 810 to display a dashboard menu 816, which includes a display options menu 818.

In some implementations, the user can launch a widget by highlighting and clicking on the name of the widget listed in the dashboard menu 816, or by clicking the widget's associated icon 820 in the widget bar 814. When the user selects a widget, the widget is scaled to fit the screen of the display device 802. The widget can be displayed anywhere in the user interface 804 including displayed over content, such as a movie, photo, game and the like. If the widget is displayed over content, the widget can be made semi-translucent so that content can be viewed through the widget. In some implementations, the content can be paused when the widget is displayed. For example, a movie that is playing in the user interface 804 can be paused on the current frame when the widget is displayed. Whether the content is paused can be determined by a user preference setting in, for example, the menu 818 or with a button or other input mechanism on the remote control device 808.

### Associating Widgets with Content

FIG. 8d illustrates an exemplary process for associating widgets with content displayed by a multimedia center application. In some implementations, widgets are displayed or become available based on the content currently displayed in the user interface 822. For example, if the content is broadcasted (e.g., a “live” broadcast), then a widget can be downloaded with the broadcast signal from a cable head-end or provided through a separate communication link (e.g., a telephone line), and displayed over the content. The widget can also be downloaded at a different time than the broadcast signal and invoked by information contained in the broadcast signal (e.g., information in the vertical blanking interval), or by some other trigger event (e.g., user interaction with a user interface element). In some implementations, the widget is included with the content on a storage medium (e.g., DVD) and is programmed to launch at a predetermined time or in response to one or more trigger events initiated by the user, the content or both. For example, while the user is viewing a musical performance a ticket widget 824 can be displayed over the content or elsewhere in the user interface 804, which can be access by the user to purchase concert tickets or receive other information related to the concert or performer. In the example shown, the widget could be triggered by a marker in the content which corresponds with a portion of the concert where the performer is not performing, or can be based on a period of inactivity (e.g., the DVD player is placed on “pause”). In some implementations, the widget can be displayed as part of a DVD menu system.

To facilitate interaction with the widget 824, the remote control device 808 can include one or more generic controls 826 that can be programmed automatically or manually to interact with the widget 824. The mapping between the controls and various parameters of the widget can automatically change to correspond to the widget currently displayed in the user interface 804. In the example shown, an remote control button assignment map 823 is displayed in the user interface to remind the user of the current functions that are mapped to the generic controls 826. Alternatively, the remote control device 808 can include dedicated controls that provide the same function for each widget displayed in the user interface 804.

In some implementations, a remote control can be programmed to provide various widget or dashboard functions using one or more controls. The functions can be programmed into the remote control device automatically (e.g. through a link with the host device or other source) or programmed by the user through a user interface on the remote control device. An exemplary remote control device that could be programmed to perform a variety of widget functions is described in U.S. patent application Ser. No. 11/249,032, for “Intelligent Media Navigation.”

Widgets that are launched in the multimedia center application can invoke other widgets and can communicate with those widgets and other resources, as described in U.S. patent application Ser. No. 11/403,644, for “Linked Widgets.”

### Display of Real-Time Information

FIG. 8e illustrates an exemplary process for displaying real-time information using a widget in a multimedia center application. In some implementations, a user can view broadcasted content, such as “live” sporting events on the display device 802. This can be accomplished through, for example, a television interface or a set-top box. In such scenarios, the multimedia center application can display a widget in the user interface 804 that is capable of receiving and display information in real-time. An example of a widget that displays real-time information is described in U.S. patent application Ser. No. 11/328,493, for “Sports-Related Widgets.”

In the example shown, a sports-related widget 830 displays in real-time the win/loss records of two baseball teams participating in a “live” broadcast of a baseball game in the user interface 804. The widget 830 can be manually or automatically downloaded from the television broadcast or from another communication link (e.g., the Internet, Ethernet, RSS feed, wireless link). The widget 830 can be updated with information on a scheduled basis or in response to a trigger event (e.g., during commercials, half time, between innings, etc.).

FIG. 8f illustrates an exemplary process for providing “live” chat sessions using widgets in a multimedia center application. In some scenarios, it may be desirable to discuss with others the content displayed in the user interface 804 in real-time using one or more widgets 832. In some implementations, the user can use the remote control device 808 or other input device to start a video and/or audio conferencing application using widgets. An example of a video conferencing application is iChat®, which is distributed as part of Apple's Tiger version of Mac OS. Other video, audio or web conferencing technologies can also be used. For example, in some applications dialog windows can be opened in a multimedia center application for receiving instant messaging text with or without video feeds of the participants.

In some implementations, the widgets 832 include drawers 834 which can be pulled open to reveal various controls for adjusting video or audio. Also included is a list of individuals currently online. Other controls for the widgets 832 are possible, such as links to web sites and other resources that include information that may be of interest to the participants.

FIG. 8g illustrates an alternative process for providing live chat sessions using widgets in a multimedia center application. In the example shown, a video display area 836 of a video conferencing widget includes three panels for simultaneously displaying video feeds of the participants and content. Each video display are 836 can be an individual widget or part of a single widget.

### Display Process

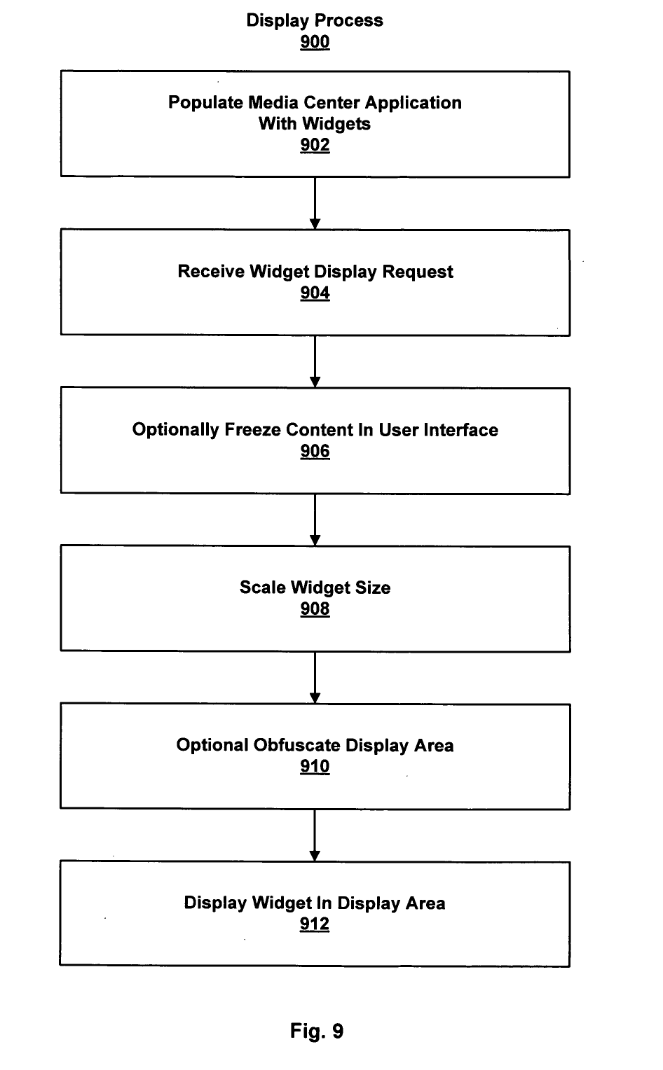

FIG. 9 is a flow diagram of an exemplary display process 900. The process 900 can be implemented on any computing platform, including in a parallel processing or multithreading environment. The process 900 begins when the multimedia center application is populated with widgets (902). Widgets can be installed with the multimedia center application or can be received and installed as part of content or through other communication means, such as network connection. Next, the process 900 receives a widget display request (904), which identifies a widget to be displayed or launched. The display request can be generated in response to a user's interaction with the multimedia center application, such as the selection of a widget from a widget bar or from a menu. If content is currently displayed, the content can be optionally paused (906) in preparation to display the widget. The widget can also be scaled as appropriate to fill a user interface generated by the multimedia center application (908). In some implementations, the user interface (including any displayed content) is obfuscated (e.g., hidden or grayed out) to enhance the visibility of the displayed widget (910). The widget can then be displayed over the content (912), which has be paused, obfuscated or will continue to play.

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

In particular, one skilled in the art will recognize that other architectures and graphics environments may be used, and that the present invention can be implemented using graphics tools and products other than those described above. In particular, the client/server approach is merely one example of an architecture for providing the dashboard functionality of the present invention; one skilled in the art will recognize that other, non-client/server approaches can also be used.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems may be used with programs in accordance with the teachings herein, or it may prove convenient to construct more specialized apparatuses to perform the method steps. The required structure for a variety of these systems will appear from the description below. In addition, the present invention is not described with reference to any particular programming language. It will be appreciated that a variety of programming languages may be used to implement the teachings of the invention as described herein. Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

It will be understood by those skilled in the relevant art that the above-described implementations are merely exemplary, and many changes can be made without departing from the true spirit and scope of the present invention. Therefore, it is intended by the appended claims to cover all such changes and modifications that come within the true spirit and scope of this invention.

What is claimed is:

1. A method of displaying widgets, comprising:
providing a user interface for a multimedia center application; and
displaying a widget in the user interface.

2. The method of claim 1, further comprising:
scaling the widget to a predetermined size prior to displaying the widget in the user interface.

3. The method of claim 1, further comprising:
displaying content in the user interface; and
displaying the widget over the content.

4. The method of claim 3, further comprising:
pausing the content when displaying the widget over the content.

5. The method of claim 3, further comprising
obfuscating the content when displaying the widget over the content.

6. The method of claim 1, further comprising:
receiving information associated with content displayed in the user interface; and
selecting the widget for display based on the information.

7. The method of claim 1, further comprising:
providing a widget manager for display in the user interface; and
displaying a widget in the user interface in response to user interaction with the widget manager.

8. A method of displaying widgets, comprising:
providing a user interface for presentation on a display device;
receiving a request from a remote control device to display a widget in the user interface; and
displaying the widget in the user interface in response to the request.

9. The method of claim 8, further comprising:
scaling the widget to a predetermined size prior to displaying the widget in the user interface.

10. The method of claim 8, further comprising:
displaying content in the user interface; and
displaying the widget over the content.

11. The method of claim 10, further comprising:
pausing the content when displaying the widget over the content.

12. The method of claim 10, further comprising
obfuscating the content when displaying the widget over the content.

13. The method of claim 8, further comprising:
receiving information associated with content displayed in the user interface; and
selecting the widget for display based on the information.

14. The method of claim 8, further comprising:
mapping functions associated with the widget to one or more controls on the remote control device.

15. The method of claim 14, further comprising:
displaying information associated with the mapping in the user interface.

16. A method of displaying widgets, comprising:
providing a user interface for a multimedia center application; and
displaying a widget in the user interface for displaying one or more participants engaged in real-time communication.

17. A computer-readable medium having stored thereon instructions which, when executed by a processor, causes the processor to perform the operations of:
providing a user interface for a multimedia center application; and
displaying a widget in the user interface.

18. A computer-readable medium having stored thereon instructions which, when executed by a processor, causes the processor to perform the operations of:
providing a user interface for presentation on a display device;
receiving a request from a remote control device to display a widget in the user interface; and
displaying the widget in the user interface in response to the request.

19. A computer-readable medium having stored thereon instructions which, when executed by a processor, causes the processor to perform the operations of:
providing a user interface for a multimedia center application; and
displaying a widget in the user interface for displaying one or more participants engaged in real-time communication.

20. A system for displaying widgets, comprising:
a processor; and
a computer-readable medium having stored thereon instructions which, when executed by the processor, causes the processor to perform the operations of:
providing a user interface for a multimedia center application; and
displaying a widget in the user interface.

21. A method, comprising:
providing a user interface for presentation on a display device; and
responsive to input from a remote control device, providing a set of user interface elements for presentation in the user interface, where at least some of the user interface elements are configured for providing access to multimedia applications, and at least one user interface element is configured for providing access to an application that performs a fixed task.

22. The method of claim 21, further comprising:
receiving input requesting access to the fixed application;
receiving output from the fixed application in response to the input;
scaling the output to a predetermined size; and
displaying the output in the user interface.

23. The method of claim 22, further comprising:
displaying content in the user interface; and
displaying the output over the content.

24. The method of claim 23, further comprising:
pausing the content when displaying the output over the content.

25. The method of claim 23, further comprising
hiding the content when displaying the output over the content.

26. The method of claim 22, further comprising:
receiving information associated with content displayed in the user interface; and
selecting the output for display based on the information.

27. The method of claim 22, further comprising:
providing a manager application for display in the user interface; and
displaying the output in the user interface in response to user interaction with the manager application.

28. A method, comprising:
providing a user interface for presentation on a display device;
receiving a request from a remote control device to display a fixed application in the user interface, where the user interface includes user interface elements for accessing multimedia applications; and
displaying output from the fixed application in the user interface in response to the request.

29. The method of claim 28, further comprising:
scaling the output to a predetermined size prior to displaying the output in the user interface.

30. The method of claim 28, further comprising:
displaying content in the user interface; and
displaying the output over the content.

31. The method of claim 30, further comprising:
pausing the content when displaying the output over the content.

32. The method of claim 30, further comprising
obfuscating the content when displaying the output over the content.

33. The method of claim 28, further comprising:
receiving information associated with content displayed in the user interface; and
selecting the output for display based on the information.

34. The method of claim 28, further comprising:
mapping functions associated with the output to one or more controls on the remote control device.

35. The method of claim 34, further comprising:
displaying information associated with the mapping in the user interface.

36. A computer-readable medium having stored thereon instructions which, when executed by a processor, causes the processor to perform the operations of:
providing a user interface for presentation on a display device; and
responsive to input from a remote control device, providing a set of user interface elements for presentation in the user interface, where at least some of the user interface elements are configured for providing access to multimedia applications, and at least one user interface element is configured for providing access to an application that performs a fixed task.

37. A computer-readable medium having stored thereon instructions which, when executed by a processor, causes the processor to perform the operations of:
providing a user interface for presentation on a display device;
receiving a request from a remote control device to display a fixed application in the user interface, where the user interface includes user interface elements for accessing multimedia applications; and
displaying output from the fixed application in the user interface in response to the request.

38. A system for displaying widgets, comprising:
means for providing a user interface for a multimedia center application; and
means for displaying a widget and one or more multimedia applications in the user interface.

39. A system, comprising:
means for providing a user interface for presentation on a display device; and
responsive to input from a remote control device, means for providing a set of user interface elements for presentation in the user interface, where at least some of the user interface elements are configured for providing access to multimedia applications, and at least one user interface element is configured for providing access to an application that performs a fixed task.

40. The system of claim 39, further comprising:
means for selecting the application that performs a fixed task from a plurality of applications that perform fixed tasks.
